(19) United States
(12) Patent Application Publication
(10) Pub. No.: US 2009/0161480 A1
(43) Pub. Date: Jun. 25, 2009

(54) Device for producing a ready-to-use filler material by mixing a binder component and a hardener component

(76) Inventor: Klaus-W. Voss, Ueterssen (DE)

Correspondence Address: FRIEDRICH KUEFFNER, 317 MADISON AVENUE, SUITE 910, NEW YORK, NY, 10017, US

(21) Appl. No.: 12/290,634

(22) Filed: Nov. 1, 2008

(30) Foreign Application Priority Data
Nov. 19, 2007 (DE) 20 2007 016 136.0
Mar. 25, 2008 (DE) 20 2008 004 098.1
Mar. 26, 2008 (EP) 08 005 451.3
Jul. 7, 2008 (DE) 20 2008 009 130.6
Aug. 18, 2008 (DE) 20 2008 010 969.8

(51) Int. Cl. B01F 15/02; B01F 15/06; B01F 15/04

(52) U.S. Cl. 366/132

(57) ABSTRACT

A device (100) for producing a ready-to-use filler material by mixing a binder component and a hardener component using a mixing device (1) having a hollow cylindrical stator part and a rotor part rotatably held in the stator part. A ring-shaped gap forms a mixing chamber Three storage containers (91, 92, 92′) are provided for the hardener component, and a first drive device (102) for actuating the hydraulic cylinders for the storage container (90) for the binder component, and for two storage containers (91, 92) for the hardener component, a second drive device (250) for the mixing device (1) and a third drive device (270) for actuating the piston rod wherein a fore-run of hardener components for 1 second, and an after run for 1 second as well as the supply of the binder component and further hardener components into the mixing device (1) are controlled, wherein the housing (101′) receives a compressed-air generating device or a source of current.

### TECHNICAL FIELD

The present invention relates to a device for producing a ready-to-use filler material by mixing at least two components, in particular a binder component and a hardener component, to form a pasty or liquid mix, according to the precharacterising part of claim 1.

### PRIOR ART

Such devices for mixing at least two components are, for example, used in the production of filler materials, wherein a hardener component at a percentile of 1 . . . 2% is admixed to a binder component in order to produce a curable filler material. For the supply of the respective components the mixing device comprises inlets by way of which the components are added to the mixing chamber. The components are stored in receptacles, such as cartridges or similar, that are arranged upstream, wherein the mixing device forms part of a device for providing filler materials.

Such a device for producing a ready-to-use filler material for the filling of surfaces, which surfaces relate, for example, to vehicle bodywork, is known from DE 203 07 518 U1. The device comprises two storage containers that are arranged on a base station, wherein one of the storage containers comprises a binder component, namely a filler material component, while the other comprises a hardener component. By means of a metering device, each of the two components is continuously fed, by way of a feed channel, to a mixing chamber in which the components are brought into contact with each other. The mixing chamber comprises a tubular section of a flexible hose upon which press rollers or cylinders act from the outside, which press rollers or cylinders squeeze the tubular section and drive it at the same time so that it rotates on a longitudinal axis. As a result of the friction and the adhesion of the components to the inside wall of the hose that occur, the components are intermixed. After the mix has passed through the tubular section it reaches an outlet that is provided on the hose, at which outlet it emerges continuously from the hose. The hose wall comprises an airtight plastic material so that the air surrounding the hose cannot get into the mix during the mixing process, and cannot be trapped in the mix in the form of pores or bubbles.

From EP 1 627 690 A a glue gun for applying in particular a two-component adhesive is known, which gun in a simple manner makes possible a wide range of mixture ratios between a relatively tenacious adhesive component and a relatively liquid adhesive component in a glue gun. This glue gun features a first cylindrical container that comprises a first piston for pressing a relatively tenacious adhesive component from a first cylindrical container; a second cylindrical container that comprises a second piston for pressing a relatively liquid adhesive component from the second cylindrical container; a mixing unit into which the first cylindrical container and the second cylindrical container lead; and drive means for moving the first piston and the second piston, wherein the drive means are designed for a higher speed of the first piston when compared to the speed of the second piston, wherein the first cylindrical container comprises a larger inside diameter than the second cylindrical container.

EP 1 570 805 A discloses a device for generating a mixture of several components, in particular for dental purposes. This device comprises at least two cartridges, wherein each cartridge comprises a component of the mixture from several components and a piston that is equipped for pressing the component from the cartridge; and a drive device for the pistons, in which drive device the drive speed is settable, wherein the drive device comprises a stepping motor. During low rotary speeds the stepping motor is to offer greater torque when compared to known direct-current motors, while it also provides high rotary speeds, even though at comparatively low torque, which is adequate for fast advance and retraction of the pistons.

U.S. Pat. No. 6,499,630 B discloses an arrangement for the release of equal proportions of two or more flowable substances from two or more syringes, at least one of which is also used on its own or in conjunction with other syringes, in particular for dental purposes. This arrangement provides for both the syringe bodies and the syringe pistons to be able to be rigidly coupled to each other, by means of detachable coupling devices, independently of the respective piston position in the direction of feed. In this arrangement the coupling devices are designed such that the pistons and/or the syringe bodies can be connected in any desired relative position to each other in the direction of feed. This arrangement further provides for the syringe bodies to be able to be coupled to each other only in a predetermined relative position, while the piston rods that are associated with the pistons can, however, be coupled to each other in any desired relative position.

However, practical experience has shown that the filler material that has been mixed with the use of the device occasionally still comprises inhomogeneities. If the filler material is applied for filling the surface of vehicle bodywork, the filler material does not cure in those locations where no hardener component is present. Remedying such faults is associated with relatively large effort and high expenditure because the filler material will have to be removed from the body by means of grinding, and afterwards the body will have to be filled anew. When such faults remain undetected during a repair procedure, and when the bodywork is subsequently painted, it will even become necessary to repaint the location anew. If the mixing device remains inoperative for an extended period of time, drying of the filler material can take place, in particular in the end region of the hose, which leads to the device being unusable. Furthermore, the hose is exposed to considerable wear and tear, because it is subjected to considerable flexing work during operation of the device. Moreover, due to the press rollers or cylinders the device is very expensive and space-intensive.

There is a further disadvantage in that the addition of the hardener component at least by means of a visual check is not possible, so that it is impossible to verify that concurrent infeed of the hardener component and of the binder component to the mixing device is ensured.

### PRESENTATION OF THE INVENTION, OBJECT, MEETING THE OBJECT; ADVANTAGES

It is thus the object of the present invention to create a device for mixing a binder component and a hardener component to form a mix in which part of the hardener component is fed to the mixing device with a fore-run when compared to the supply of the binder component and further hardener components, so that when the binder component enters the mixing chamber there is already a small quantity of hardener component present in said mixing chamber of the mixing device. Furthermore, equalisation of the fill heights in the storage containers for the binder component and the hardener component is to be achieved so that at commencement of drawing off the two components from the storage containers it can be assumed that the surface heights of the hardener component and of the binder component in their storage containers are identical, wherein the device is to be designed as a floor-model device or a wall-model device or a mobile device.

Preferably, the device is to be designed as a trolley so that feed hoses and electrical cables are avoided in order to thus create a fully functional device that can be used in very large facilities or production halls.

A further object of the invention consists of keeping the binder component A, by means of cooling of the binder component A, e.g. at a temperature that makes it possible to improve, i.e. extend, the pot life of the mixed reaction components that comprise the hardener component B and the binder component A, thus delaying the reaction time.

This object is met based on a device according to the precharacterising part of claim 1 in conjunction with its characterising features.

The invention includes the technical teaching according to which the device, for producing a ready-to-use filler material for the filling of surfaces, in particular of vehicle bodywork, by mixing at least two components, in particular a binder component A and a hardener component B, by means of a mixing device comprising a hollow cylindrical stator part and a rotor part that is held in said stator part so as to be concentrically rotatable on a longitudinal axis, and a ring-shaped gap that is created between the rotor part and the stator part and that forms the mixing chamber to form a pasty or liquid mix, wherein the mixing device comprises at least one lead-in nozzle for the supply of the binder component A and at least one further inlet for the supply of the hardener component B, as well as a dispensing opening for dispensing the mix, wherein between the lead-in nozzles and the dispensing opening the mixing chamber is designed, within which mixing chamber the components A, B intermix, comprises a supporting plate with two perpendicularly standing column-like braces which in the upper region are connected by way of a transverse brace, between which braces is arranged a filling head, which forms a support plate, with holding devices and receiving devices for a storage container for the binder component A and for three storage containers for the hardener component B, B1, B2 with piston rods that are guided in the storage containers, which piston rods are connected to hydraulic cylinders, wherein an attachment- and guide element for the piston rods is provided above the storage containers, and a first drive device for actuating the hydraulic cylinders or the piston rods for the storage container for the binder component A is provided, and a second drive device for two storage containers of the three storage containers for the hardener component B, B1, B2 and for the mixing device is provided, and a third drive device for actuating the hydraulic cylinder or the piston rod for the third storage container for the hardener component B2 is provided, wherein the three motor-driven drive devices are brought together in a program switching device or a control device such that prior to commencement of the mixing process and of actuation of the hydraulic cylinders or of the piston rods for the storage container for the binder component A and for the two storage containers for the hardener components B, B1, the third drive device for the third storage container for the hardener component B2 is operated independently of all other functions, so that prior to commencement of the actual mixing process a fore-run of hardener component B2 takes place for approximately 1 second, wherein after commencement of the rotary movement of the rotor part of the mixing device and the supply of the binder component A and of the hardener components B, B1 the third drive device for the third storage container for the hardener component B2 is operated with an after-run of 1 second for a further supply of hardener component B2, wherein in the case of complete discharge of the third storage container for the hardener component B2 and a toothed rack as a piston rod, driven by the third drive device that is arranged in a box-like container on the transverse brace of the two braces of the base, has reached the lower region of the third storage container for the hardener component B2, in a further downwards movement lifts the box-like container, which is attached on one side to the longitudinal brace by means of a hinge, such that the box-like container is lifted by approximately 2 mm, wherein by way of this movement of the box-like container a visual signalling device is operated, and for exchanging the empty third storage container for the hardener component B2 for a full storage container the entire device is made inoperative, wherein the supporting plate is designed so as to be movable, and for actuation of the hydraulically operated drive devices for the piston rods for the storage containers comprises a compressor, or for operation of the electric-motor-driven drive devices for the piston rods for the storage containers and for operation of the mixing device comprises a source of current, and wherein the device is designed as a wall-model or floor-model device that is designed so as to be mobile, driven manually or by motor. Advantageous improvement of the invention are stated in the dependent claims.

According to a further embodiment, the supporting plate of the device comprises a filling head, designed as a support plate, for receiving the storage container for the binder component A and for receiving the three storage containers for the hardener components B, B1, B2, wherein the four storage containers are positioned on the filling head in a non-slip or fixed manner, wherein their outlets correspond to inlets of feed channels in the filling head, whose outlets can be brought into effective connection with the lead-in nozzles for the binder component A and for the hardener components B, B1, B2 of the mixing device or with the lead-in nozzles for the hardener components B, B1, B2 of a catch container that can be exchanged for the mixing device, for receiving and disposal of the quantity, determined by overfilling, of hardener component B, B1, B2 in the storage containers for the hardener components B, B1, B2, and wherein the storage containers in their interior spaces comprise plate-shaped pistons that impinge on the container contents, with piston rods that are movable in longitudinal direction of the containers, by means of motor-drivable hydraulic cylinders or drive devices that are designed in some other way, or by manual operation, by means of which pistons or piston rods the contents of the storage containers for the binder component A and for the hardener components B, B1, B2 can be pressed into the mixing device, or partial contents of the storage containers for the hardener components B, B1, B2 can be pressed into the catch container.

Furthermore, the invention is based on the fact that the fill heights of the hardener component B and of the binder component A in their storage containers are different, which results in mixing ratios between the two components at commencement of drawing off being obtained that comprise a larger quantity of hardener components so that a predetermined and also required mixing ratio is not achieved. For, already at commencement of drawing off the components from their storage containers at a quantity required for the mixture, it is absolutely necessary that the surface height both of the binder component A in its storage container and of the hardener component B, B1 in their storage containers are precisely equalised. For this reason the fill heights above the storage containers for the hardener component B, B1 are higher than the fill height of the binder component A in its storage container. In most cases this overfilling is approximately 10 mm. When inserting a new storage container for the binder component A and inserting the storage containers for the hardener components B, B1 into the mixing device, first of all harmonisation of all three components A, B, B1 is to be brought about. This is achieved in that a grip-like handle, provided on the piston rods, is manually operated, by means of which handle first of all the piston rods in the storage containers for the hardener components B, B1 are moved until the overfilled quantity of hardener component B, B1 is pressed out of the storage containers and placed in the catch container that has been inserted in the device. In this arrangement operation of the handle takes place until such time as the plate-shaped piston in the storage container for the binder component A has impinged on said binder component A; at this point the overfilled quantity of hardener component B, B1 has been pressed out.

In order to bring the fill height of the hardener components B, B1 to the fill height of the binder component A, the handle of the device, which handle is designed as a tension lever, is operated at half the height of the piston rods or of the compressed-air cylinder. After insertion of the new storage container for the binder component A and the two cartridge-like storage containers for the hardener component B, B1 in the device, the handle is pulled downwards with full force, i.e. with approximately 30 kg, until it does not move any further. At this point all the fill heights have been equalised. Since the binder component A has far greater viscosity than the hardener component B, B1, and since the size of the surface of the binder component A in its storage container amounts to 98% of the total surface, it is not possible to press binder component A from its storage container by manual force, because the binder component A requires a pressure of approximately 2 bar in order to emerge at the bottom from the outlet of the storage container or from the outlet of the filling head. In a 10 kg storage container for the binder component A a pressure of 0.15 bar is exerted on the binder component A. This is, of course, not sufficient for the transport of binder component A, which transport would require 400 kg of tensile force. This is not achievable. In a 3 kg storage container for the binder component A a tensile force of 30 kg exerts a pressure of 0.4 bar on the binder component A. This is also not enough to press binder component A from its storage container into the mixing device. Manual force is thus never sufficient to press out any binder component A. In order to remove the overfill in the storage containers for the hardener component B, B1, the nozzle stubs of the catch container are inserted in the outlets of the filling head of the device for the hardener component B, B1, after which the handle is pulled downwards at full force. At this point the operational readiness for mixing with the device and its mixing device has been established. The catch container that receives the quantity of overfill of the hardener component B, B1 is then exchanged for the mixing device, so that the mixture of binder component A and the hardener components B, B1 can be produced. All the subsequent mixtures do not require any removal of overfill; this is only required again when new storage containers for the binder component A and the hardener component B, B1 are inserted into the device.

According to an embodiment of the invention the catch container comprises a cup-shaped formed piece that is cylindrical or comprises some other geometric cross-sectional form and that is closed on one side, with the wall of said formed piece comprising two nozzle stubs, arranged side by side and communicating with the interior space of the formed piece, which nozzle stubs are arranged and designed such that by means of the nozzle stubs that can be inserted into the outlets of the filling head for the hardener components B, B1, the catch container can be clipped onto the filling head. If the catch container is no longer required, said catch container is pulled from the filling head, and the mixing device is clipped on.

On its wall surface opposite the two nozzle stubs the formed piece of the catch container comprises a nozzle stub which, for holding and centring the catch container, is engaged by the handle or clamping device provided on the device or by the drive shaft for the mixing device.

The mixing device comprises a hollow cylindrical stator part and a rotor part that is held in said stator part so as to be concentrically rotatable on a longitudinal axis, wherein the mixing chamber is formed as a ring-shaped gap between the stator part and the rotor part, wherein several first mixing teeth formed on the stator part extend radially inwards, and several second mixing teeth formed on the rotor part extend radially outwards into the mixing chamber so as, by means of rotational movement of the rotor part, to move the mixing teeth in the stator part relative to each other, thus achieving mixing of the components A, B, B1, B2, wherein the stator part comprises three inlets, connected to the mixing chamber, for the hardener component B, B1, B2.

At its end facing away from the inlets, the stator part comprises a ring-shaped holding device with attachment openings, which holding device can be undone in the manner of a bayonet connection and is rotatably connected to the stator part, wherein rotatability is limited by means of end stops such that a fit of the inlet for the binder component A with the infeed for the binder component A and at the same time a fit of the inlet apertures for the hardener component B, B1, B2 with the infeed devices for those of the hardener components is achieved.

This ring-shaped holding device comprises two opposing slot-shaped openings that extend in a curved shape parallel to the circumferential edge of the holding device, of which slot-shaped openings each comprises two guide sections of different width, of which the respectively wider guide section is designed for inserting an L-shaped guide cam that is formed on the lower circumferential edge of the stator part, wherein the width of the wider guide section corresponds to the length of the free angled limb of the guide cam, and of which guide sections the respective narrower guide section comprises a width that corresponds to the thickness of the limb of the L-shaped guide cam, which limb has been formed to the lower circumferential edge of the stator part and extends parallel to the longitudinal direction of the mixing device.

An advantageous embodiment of the present invention provides for the inlets to lead directly into the mixing chamber of the mixing device, wherein there are three inlets for the supply of the hardener component so as to create a redundant supply of the mix with the hardener component, and so as to create the option of being able to feed hardener component B2 from the third storage container with fore-run and after-run to the mixing chamber of the mixing device. The requirement of redundant supply of the hardener component is based on the recognition that inhomogeneities in the mix are normally caused by trapped air in the hardener component; in practical application such trapping of air cannot be reliably prevented, even with careful production of the hardener component. Since the hardener component comprises a percentage of less than 5%, preferably only approximately 2%, of the total volume of the mix, even the most minute quantities of trapped air in the hardener component can result in locations in the mix that do not contain any hardener component and thus do not cure. Since in the device according to the invention preferably two storage containers are provided for the hardener component and are connected to the mixing chamber by way of separate feed channels, in a case where an air bubble is contained in one of the feed channels, nonetheless, the hardener component can continue to be supplied to the mixing chamber by way of the second feed channel. The danger of all the feed channels containing air bubbles of the hardener component at the same time is reduced many times and is thus negligible. The device can, for example, be used for the following binder systems: polyester resins (unsaturated), peroxide styrene systems, epoxy resins (two-component), polyurethane resin systems (two-component), phenolic resin systems, silicon systems (two-component), acrylate systems (two-component) or thiocol systems (polydisulphide systems).

In order to be able to check the supply of the hardener component B, B1, B2 by means of a visual inspection, it is provided for at least the stator part to be made from a transparent material, wherein the transparent material is selected from the group of plastics comprising polycarbonate (PC), polymethylmetacrylate (PMMA) and/or styrene acrylonitrile (SAN). In this arrangement it is, furthermore, particularly advantageous if the hardener component is dyed. The supply of the hardener component is visible through the transparent stator part so that during operation of the mixing device the operator can keep an eye on the supply of the hardener component.

A further advantageous embodiment of the invention provides for the first mixing teeth to be arranged on at least one first mixing tooth plane, and the second mixing teeth to be arranged on at least one second mixing tooth plane, and for the mixing tooth planes axially in the direction of the longitudinal axis to be offset in relation to each other in the manner of levels so that the second mixing teeth of the rotor part radially rotate in the respective gaps of the first mixing teeth of the stator part. In total from the first mixing teeth of the stator part five mixing tooth planes can be provided, so that in the respective gaps the second mixing teeth of the rotor part are arranged on a total of four mixing tooth planes. In this arrangement the mix passes from the inlet to the dispensing opening the total of five mixing tooth planes of the first mixing teeth as well as the four mixing tooth planes of the second mixing teeth.

Advantageously in each instance the mixing teeth comprise facing areas which in axial direction face each other, in order to position them against each other in the case of an axially acting force between the stator part and the rotor part. Furthermore, in relation to a plane that is arranged normally to the rotational axis the facing areas are inclined at an angle α so that during the mixing process the facing areas slide on each other without material being removed from the mixing teeth and reaching the mix. In this way it is possible to keep the length of the rotor part short in the direction of the rotational axis, so that after use of the rotor part or of the stator part only a corresponding residual quantity of the mix remains in the mixing chamber. In this way the device makes it possible to keep consumption of the components low. During the mixing process the mixing teeth of the rotor part and the mixing teeth of the stator part are pushed against each other as a result of the conveying pressure of the components, wherein the facing areas that extend at an inclination to each other slide one on top of the other without the teeth abrasively removing material which would enter the mix. In this arrangement the components of the mix form a thin film between the facing areas that slide on each other, which film acts as a sliding layer. The angle α, at which the mixing teeth are inclined towards each other in relation to the plane normally arranged to the rotational axis can comprise at least 5°, if need be 10°, and preferably at least 15°.

A further advantageous embodiment of the invention provides for the stator part to comprise a support bearing area on which the rotor part rests against the face of the mixing teeth that have been formed to said rotor part, and slides off in order to create an axial slide bearing arrangement. At first the rotor part is inserted into the stator part by way of an open end face, which points away from the inlets, until said stator part contacts the support bearing area with the mixing teeth. This makes possible a one-sided axial bearing arrangement of the rotor part in the stator part. The geometry of the rotor part is matched such that when the mixing teeth come to rest facing the support bearing area, the second mixing teeth of the rotor part are situated in the respective gaps of the first mixing teeth of the stator part. Axial support of the rotor part takes place in the direction of joining the rotor part to the stator part against the support bearing area, wherein during axial play in the direction of the opening of the stator part there is a danger of the first and the second mixing teeth contacting each other. Due to the facing areas, which are arranged at an angle α, the rotor part is returned towards the support bearing area in the direction of joining, from which the rotor part is slid into the stator part.

A further advantageous embodiment of the device consists of the load-bearing structure of the device comprising a protective cover, that is to be opened and that is preferably transparent, for covering the storage containers, wherein particularly preferably a protective switch that is in effective connection with the protective cover and with the device is provided, which protective switch switches the device off when the protective cover is open, which protective cover comprises a transparent plastic or some other suitable material, wherein said protective cover is designed in a door-like manner.

Furthermore, the load-bearing structure of the device comprises front and/or rear receptacles for receiving spent or new mixing devices.

In order to be used as a floor-model device, the device comprises a base plate or an H-shaped base.

In order to be able to move the device, according to a further embodiment, the supporting plate that receives the device, which supporting plate can also be housing-like in design, is designed so as to be movable, wherein mobility can be achieved so as to be manual or by motor-drive, preferably by electric-motor-drive. To this effect the supporting plate or the housing comprises rollers that are connected to a drive motor which together with a source of current, in particular a rechargeable battery, preferably for 24-volt operation, and a pressure container with a receiving volume of 25 litres or 50 litres or a larger quantity for compressed air, is arranged on the supporting plate or in the housing, wherein it is also possible to provide a compressor for generating compressed air. A device designed in this manner requires neither a current connection nor a compressed-air connection and is thus suitable for use in large plants with large production halls, for example of a length of 100 metres or more. For all the motor drives of the device 24-volt current from the rechargeable battery is thus available, wherein all the drive motors of the device are designed for 24-volt operation. Hydraulic drive devices, i.e. drive apparatus of the device, which apparatus is operated by compressed air, receive the compressed air from the pressure container that is arranged on the supporting plate or in the housing and that is filled with compressed air, which pressure container can time and again be filled anew with compressed air, which can, for example, take place by means of the compressor provided. For example, if the storage container that holds 10 kg of binder component A is still full, less compressed air is used for filling the hollow space of the drive cylinder than is required later. As a result of the mobility of the device, it can be driven to any location where filler material is used.

A further embodiment to provide mobility for the device provides for the device to be designed as a floor-model device comprising a base plate or an H-shaped base, wherein the device is arranged and held on a transport table comprising rolls, which transport table comprises a top supporting plate to receive the device, and a further shelf-like supporting plate that receives the container that receives compressed air, a compressed-air generator and a source of current, preferably a rechargeable battery and/or a drive motor, in particular to provide mobility for the transport table.

Because the device comprises rollers, and can thus be moved, the device is completely self-sufficient; it can be moved to any processing location so that long travel associated with a device that is affixed to a location in the production hall or workshop can be avoided. Filler material can be produced directly at the location of use, without this requiring connections for compressed air or electrical current. Thus the supply of compressed air and/or electrical current for all the drive devices of the device is ensured.

It has been shown that when the device is used in warmer climates or at higher ambient temperatures faster reaction of the mixed reaction components such as hardener component B and binder component A occurs, which is perceived to be disadvantageous because the reaction mixture comprising binder component and hardener component cures before the filler material is used. It is thus necessary to extend the pot life of the reaction mixture, i.e. the time span is to be extended in which the portion of the reaction components after mixing of the hardener component B and the binder component A remains workable.

Thus in order to extend the pot life of the reaction components such as hardener component B and binder component A, the invention provides for the binder component A to be held at a temperature on the basis of which it is possible to delay the reaction time of the two mixed components A and B. This is achieved in that in order to extend the pot life of the reaction components, such as hardener component B and binder component A, for the purpose of cooling the binder component A, the storage container comprising the binder component A is in effective connection with a refrigeration system.

To this effect the following technical designs are proposed as exemplary embodiments:

In order to cool the binder component A the storage container that receives this component is arranged in a closed container with a container insert opening that comprises a closable door, with the interior space of said container being in effective communication with the refrigeration system of a cooling device which is preferably designed as a Peltier refrigeration system, wherein the cooling device is arranged on the base plate or the base of the device or on the movable transport table.

In a further embodiment, for the purpose of cooling the binder component A its storage container is arranged on a support- and base plate, placed onto the filling head of the device, as a cold-transport plate comprising at least one channel system, arranged in a ring-shaped manner or in some other manner, for the infeed and discharge of coolant, which storage container is connected with a cooling device arranged on the base plate or the base of the device, or on the movable transport table, wherein a cold-insulation layer is arranged between the support- and base plate for the storage container with the channel that carries the coolant on the one hand, and the non-cooled filling head on the other hand.

### BRIEF DESCRIPTION OF THE DRAWINGS

The invention is illustrated in the drawings with reference to exemplary embodiments. The following are shown:

FIG. 1 a diagrammatic view of a mobile device for producing a ready-to-use filler material for the filling of surfaces, e.g. of vehicle bodywork, with a device for mixing two components, comprising a stator part and a rotor part, wherein both parts comprise intermeshing mixing teeth, and comprising a Peltier element for cooling the storage container with the binder component;

FIG. 2 a diagrammatic view of the mobile device with a holding device, comprising two columns connected by way of a transverse brace, for the piston rods and their drives for the storage containers for the binder component and for the hardener component, and with a protective cover in its open state;

FIG. 3 a diagrammatic view of the mobile device with a holding device, comprising two columns interconnected by way of a transverse brace, for the piston rods and their drives and with the closed protective cover;

FIG. 4 a diagrammatic view of the mobile device with a storage container for the binder component and with three storage containers for the hardener component;

FIG. 5 a lateral view of the mobile device according to FIG. 4;

FIG. 6 a diagrammatic view of the mobile device with three storage containers for the hardener component;

FIG. 7 a further diagrammatic view of the mobile device with the storage device for the binder component arranged in a closed air-conditioned container, with the storage containers for the hardener component having been removed from the device;

FIG. 8 a diagrammatic view of a device arranged on a mobile transport table, which device is designed as a floor-model device, for producing a ready-to-use filler material;

FIG. 9 a perpendicular section of part of the filling head of the device with a support- and base plate for the storage container for the binder component in place with at least one channel carrying coolant;

FIG. 10 a horizontal section of the support- and base plate for the storage container for the binder component with a channel for the coolant, which channel comprises an inflow and an outflow;

FIG. 11 a top view of the support- and base plate with a storage container for the binder component in place, with channels inset in the plate, for a coolant circulation system;

FIG. 12 a diagrammatic view of part of the device with a storage container for the binder component and with three storage containers for the hardener component;

FIG. 13 a diagrammatic view of a filling head, designed as a base plate for the storage container for the binder component, comprising inlets and outlets, inlets for the components, and outlets that are connected to the inlets by way of feed channels, wherein a mixing device and a catch container for receiving quantities of hardener components, which quantities result from overfilling in the storage containers for the hardener components, are associated with the filling head;

FIG. 14 a front view of the filling head with the outlets for the binder component and for the two hardener components;

FIG. 15 a top view of the filling head with the inlets for the two hardener components;

FIG. 16 a diagrammatic partial section view of the filling head with storage containers for the binder component and for the two hardener components in place, with a catch container associated with the filling head;

FIG. 17 a part projection and part perpendicular section of the storage container for the binder component and for the two storage containers with hardener components that have been overfilled when compared to the binder component;

FIG. 18 a part projection and part perpendicular section of the storage container for the binder component and for the two storage containers for the hardener components after the overfill of hardener components has been pressed from their storage containers, wherein the quantity of overfilled hardener component that has been pressed from the storage containers has been placed into the catch container;

FIG. 19 a diagrammatic view of the catch container;

FIG. 20 a perpendicular longitudinal section of the catch container;

FIG. 21 a diagrammatic view of the mixing device comprising the stator part and the rotor part, with controllable infeed devices for a binder component and two hardener components from storage containers connected to the mixing chamber, wherein the stator part, at its end facing away from the infeed devices for the components, comprises a ring-shaped holding device which is detachably attached to the stator part and is firmly connected to the device;

FIG. 22 an enlarged top view of the ring-shaped holding device;

FIG. 23 an enlarged bottom view of the ring-shaped holding device;

FIG. 24 a perpendicular section according to line A-A of FIG. 22;

FIG. 25 a bottom view of the stator part of the mixing device, with guide cams engaging the holding device;

FIG. 26 a lateral view of part of the stator part with the guide cams formed to said stator part;

FIG. 27 a diagrammatic disaggregated component drawing of the mixing device with the stator part and the rotor part;

FIG. 28 a diagrammatic view of the stator of the mixing devices with the infeed devices for the binder component and for the hardener component;

FIG. 29 a view of the mixing device in which the rotor part is inserted in the stator part, and the stator part is shown in section view;

FIG. 30 a cross-section of the mixing device comprising a section view of the stator part and a section view of the rotor part;

FIG. 31 a longitudinal section of the stator part;

FIG. 32 a top view of the stator part, wherein the top view is of the end from the direction of the inlet;

FIG. 33 a lateral view of the rotor part of the mixing device; and

FIG. 34 a partial cross-section view of the rotor part and of the stator part along a mixing zone within the mixing chamber, which mixing zone extends circumferentially in a ring-shape, wherein in the diagram the teeth of the stator part are shown hatched and the teeth of the rotor part are shown non-hatched.

### THE BEST WAY OF IMPLEMENTING THE INVENTION

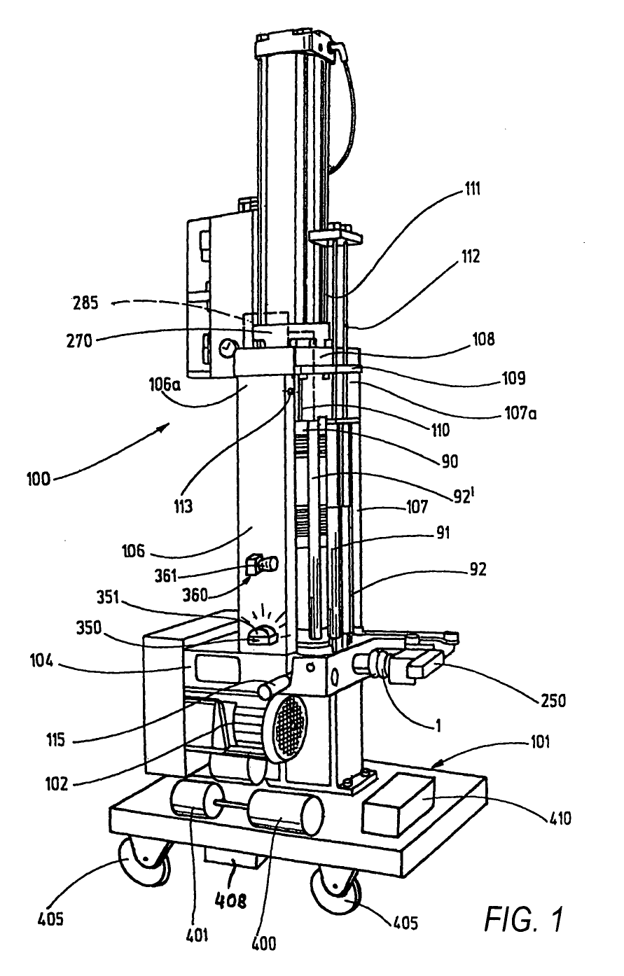

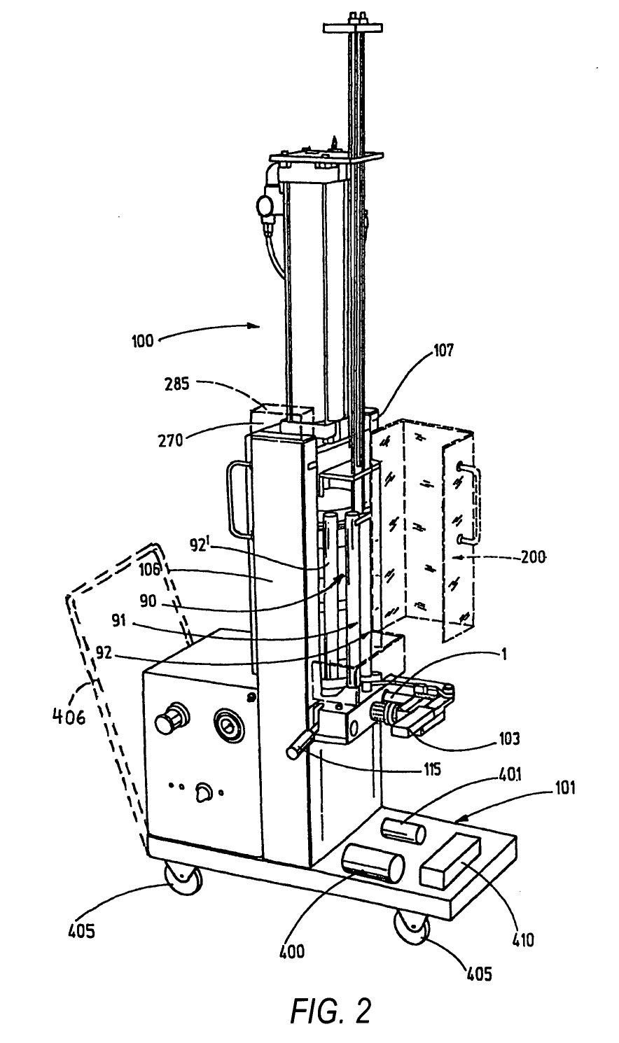

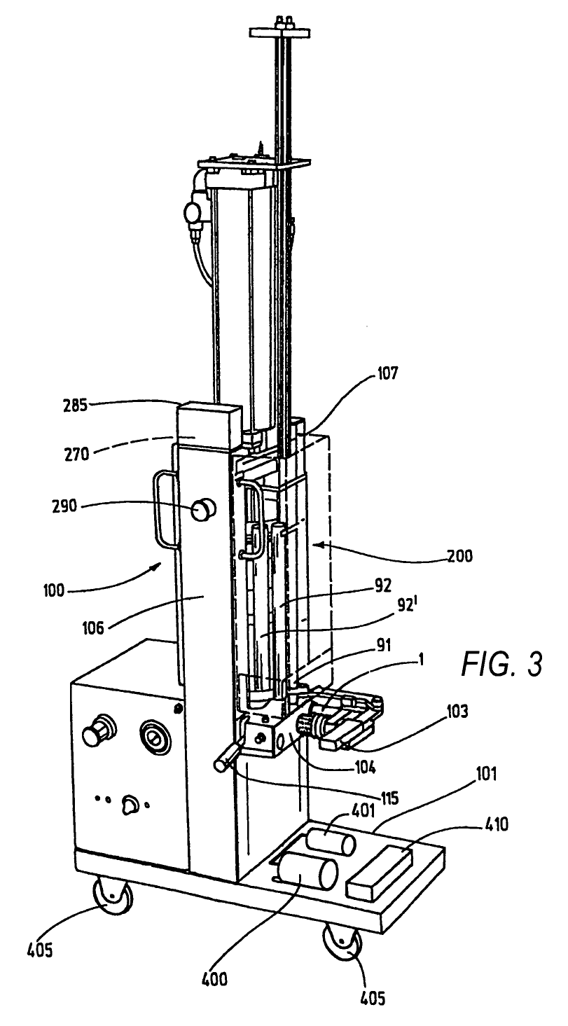

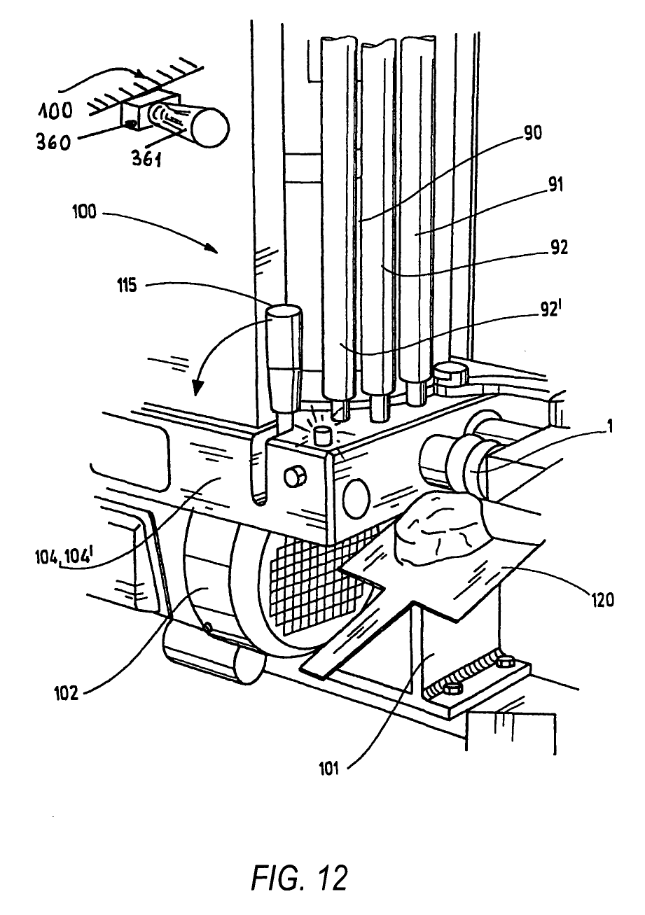

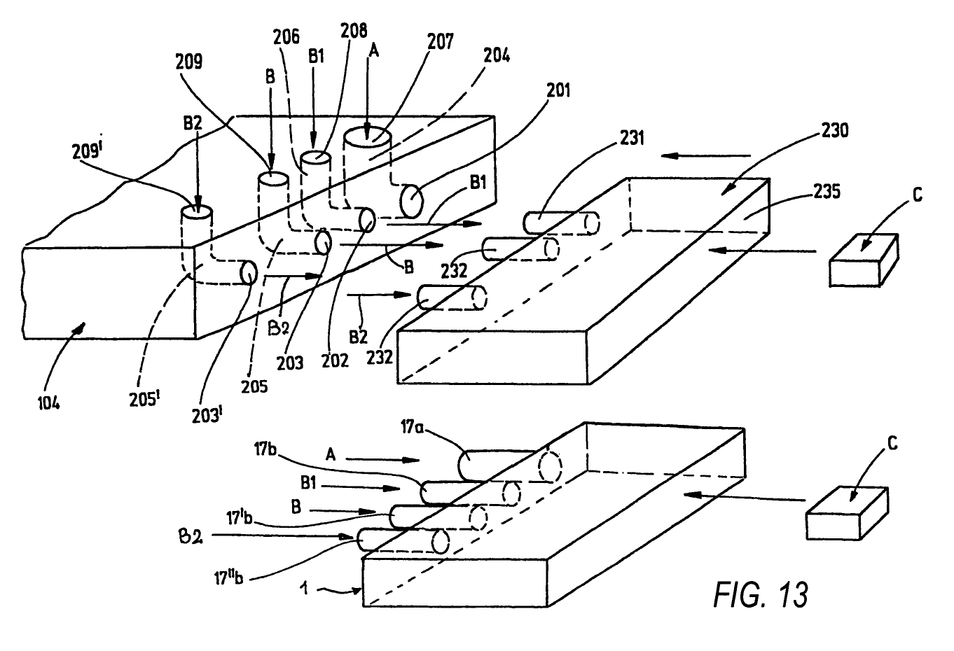

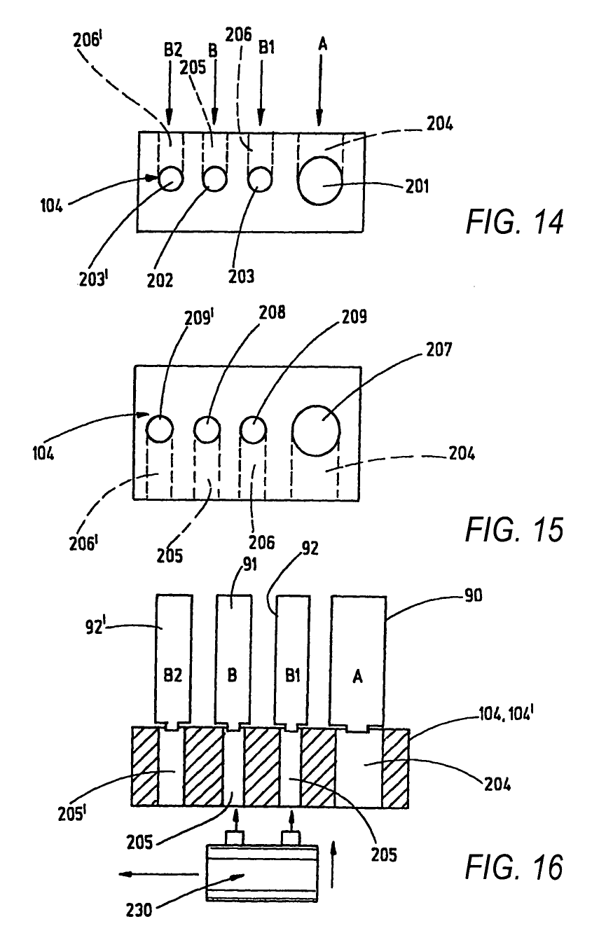

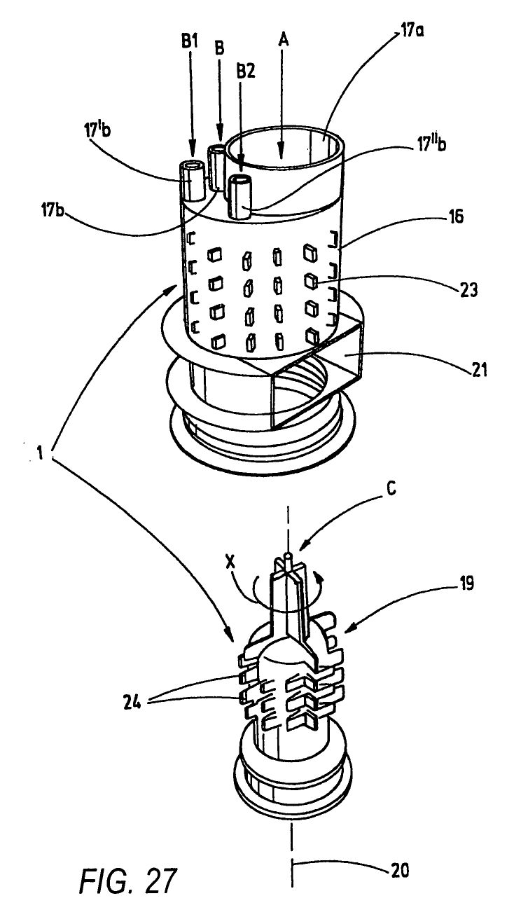

The mobile device 100, shown in FIG. 1, for producing a ready-to-use filler material for the filling of surfaces for example of vehicle bodywork, which filler material comprises a binder component A and a hardener component B, comprises a supporting plate 101 with a first drive device 102 and a holding device 103 for a mixing device 1 comprising a stator part 16 and a rotor part 19 (FIG. 27), wherein between the two cylindrical parts 16 and 19 a ring-shaped gap is created that forms the mixing chamber 14. The holding device 103 with its handle 103a at the same time receives a second drive device 250 for the mixing device 1 (FIGS. 1, 6 and 7). On the supporting plate 101, braces 106, 107 are arranged, which in the region of their upper free ends are interconnected by way of a transverse brace 108. Between the perpendicular braces 106, 107, the filling head 104 that is designed as a support plate 104′ is arranged (FIG. 2). This plate-shaped filling head 104 at the same time serves as a support- and base plate 104′ to receive a storage container 90 for the binder component A and, in the embodiment shown in FIGS. 3, 4 and 12, three storage containers 91, 92, 92′ for hardener components B, B1, B2. The storage containers 90, 91, 92, 92′ are positioned on the filling head 104 in a non-slip or fixed manner. The outlets of the storage containers 90, 91, 92, 92′ correspond to the inlets 207, 208, 209, 209′ of feed channels 204, 205, 206, 206′ in the filling head 104 (FIG. 12), wherein these feed channels in turn are connected to the lead-in nozzles 17a, 17b, 17′b, 17″b of the mixing device 1 when the device 100 starts operation. Thus the outlets of the storage containers 90, 91, 92, 92′ correspond to the inlets 207, 208, 209, 209′, which inlets 207, 208, 209, 209′ are provided in the filling head 104, of the feed channels 204, 205, 206, 206′, whose outlets are designated 201, 202, 203, 203′ (FIGS. 13, 14 and 15).

The supporting plate 101 can also be designed as a housing 101′ and can be movable in the same manner as the supporting plate 101 (FIGS. 2, 3, 4, 5, 6 and 7).

The four storage containers 90, 91, 92, 92′ are positioned on the filling head 104 in a non-slip and fixed manner.

The outlets 201, 202, 203, 203′ of the feed channels 204, 205, 206, 206′ are connected to the lead-in nozzles 17a, 17b, 17′b, 17″b for the binder component A and the hardener components B, B1, B2 of the mixing device 1 or the lead-in nozzles 231, 232, 232′ for the hardener components B, B1, B2 of a catch container 230 that can be exchanged for the mixing device 1, which catch container 230 serves to receive and dispose of the quantity of hardener components B, B1, B2 in the storage containers 91, 92, 92′ for the hardener components B, B1, B2 (FIGS. 13, 18 and 20), which quantity has been predetermined by overfilling.

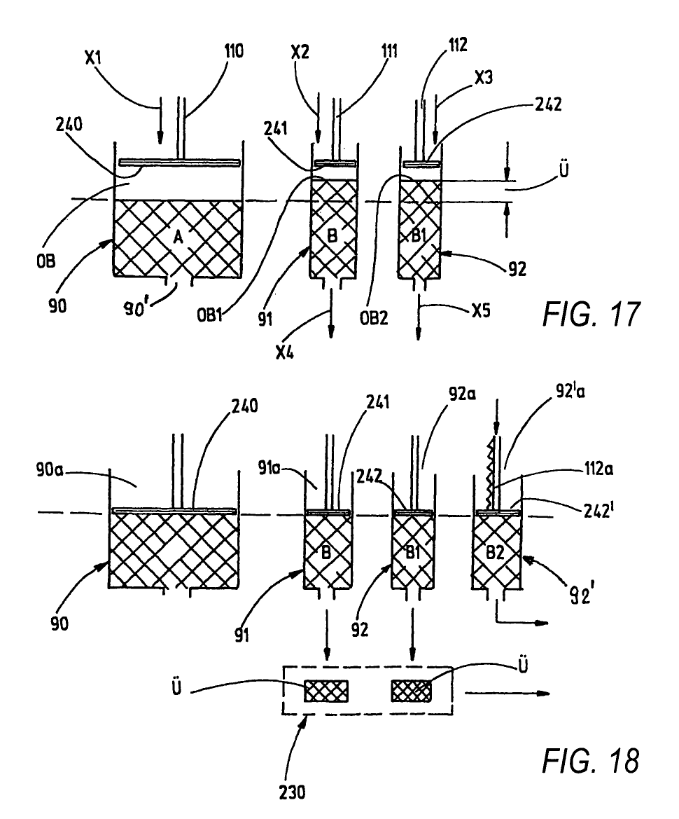

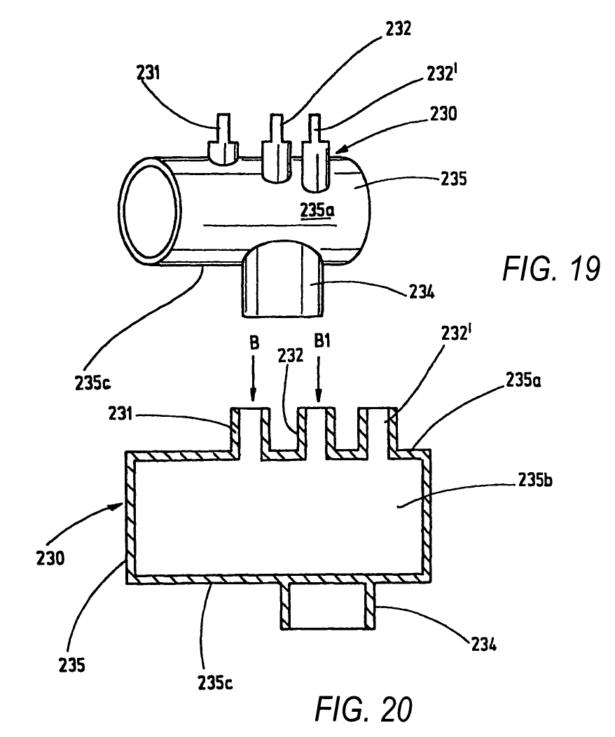

In their interior spaces 90a, 91a, 92a, 92′ the storage containers 90, 91, 92, 92′ comprise plate-shaped pistons 240, 241, 242, 242′ that impinge on the container contents with motor-driveable hydraulic cylinders or drive devices that are designed in some other way or by means of piston rods 243, 244, 245, 245′ that are movable in longitudinal direction of the containers by manual operation, by means of which piston rods 243, 244, 245, 245′ the contents of the storage containers 91, 92, 92′ for the binder component A and for the hardener components B, B1, B2 can be pressed into the mixing device 1, or partial contents of the storage containers 91, 92, 92′ for the hardener components B, B1, B2 can be pressed into the catch container 230 (FIGS. 17 and 18).

The catch container 230 comprises a cup-shaped formed piece 235 that is cylindrical or comprises some other geometric cross-sectional form and that is preferably closed on one side, with the wall 235c of said formed piece 235 comprising two nozzle stubs 231, 232 that communicate with the interior space 235b of the formed piece 235, which nozzle stubs 231, 232 are arranged and designed such that by means of the nozzle stubs 231, 232, 232′ that can be inserted in the outlets 202, 203 of the filling head 104 for the hardener components B, B1, B2 the catch container 230 can be clipped onto the filling head 104.

If hardener component is fed to the filling head 104 from several storage containers, then the catch container 230 comprises a corresponding number of nozzle stubs 231, 232, 232′.

By means of a motor-driven hydraulic cylinder or several motor-driveable hydraulic cylinders 110, 111, 112, 112′ piston rods are driven, whose free ends that are located in the interior spaces 90a, 91a, 92a, 92′a of the storage containers 90, 91, 92, 92′ bear plate-shaped pistons 240, 241, 242, 242′ so that during actuation of the hydraulic cylinders 110, 111, 112, 112′ the piston rods with the pistons 240, 241, 242, 242′ that are located in the interior spaces of the storage containers 90, 91, 92, 92′ are moved in longitudinal direction of the piston rods in order to press the contents of the storage containers 90, 91, 92, 92′ into the mixing device 1 (FIGS. 1, 2, 3, 4 and 5). Operation of the motor of the drive device 102 for actuating the hydraulic cylinders, i.e. switching on and switching off, is controlled by way of the actuating lever 115 so that the desired quantity of the produced filler material can be removed using a spatula 120, wherein at the same time switching on and switching off the drive 250 for the mixing device 1 take place (FIGS. 1 and 12).

FIGS. 2, 3, 4 and 5 show further three-dimensional views of the device 100 shown in FIG. 1. On the filling head 104, container receiving devices for the binder component A and for the hardener components B, B1, B2 are provided. Within the container receiving devices profiled sections can be provided in order to ensure the stability of the storage containers 90, 91, 92, 92′.

The device 100 shown in FIG. 1 comprises a device 1 for mixing two components, namely the binder component A and the hardener components B, B1, B2. The individual components A, B, B1, B2 are fed to this mixing device by way of the feed channels 204, 205, 206, 206′ of the filling head 104.

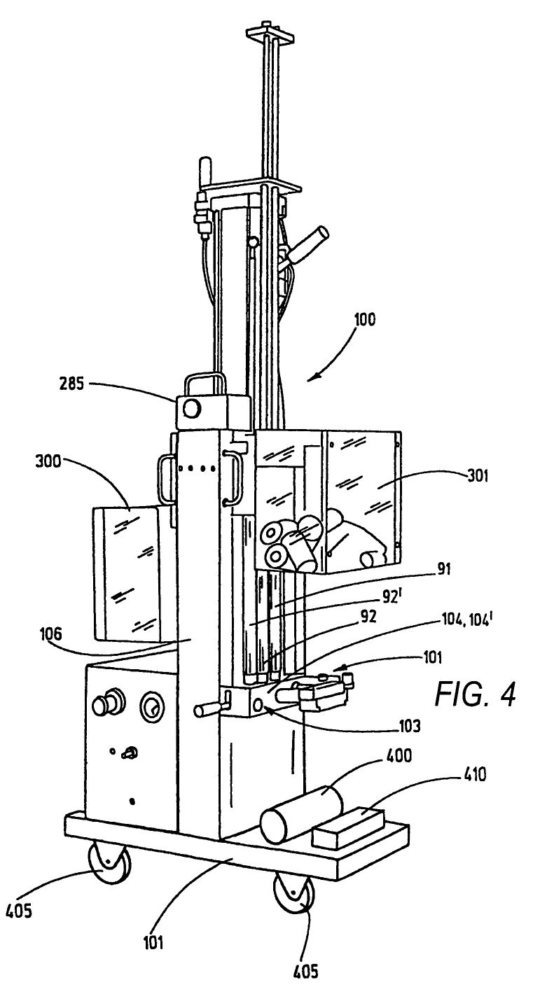

According to FIGS. 4 and 12, apart from the storage container 90 for the binder component A, the device 100 comprises two storage containers 91, 92 for the hardener components B, B1 and in addition a further storage container 92′ for a further hardener component B2. This storage container 92′ is arranged in a stable manner on the filling head 104 or on the support plate 104′. In a manner that is analogous to that of the other storage devices 91, 92, its content is pressed out of the container when the device starts operation, with the contents reaching the mixing device 1 by way of the filling head 104, wherein the outlet of the storage container 92′ corresponds to a feed channel 206 in the filling head 104 or in the support plate 104′ (FIGS. 13, 14, 15 and 16). Pressing the hardener component B2 from the storage container 92′ takes place by means of the drive device 270 by way of a hydraulically driven or motor driven piston rod 112′ with a piston plate 242′ affixed towards the end, wherein the piston rod 112′ is designed as a toothed rack that is in functionally effective connection with the third drive device 270. For actuating the hydraulic cylinder or the piston rod 112′ (FIGS. 17 and 18), the third drive device 270 is arranged on the column-like brace 106 of the device 100 in a box-shaped container 285. The motor-driven drive devices 102, 270 and the motor-driven drive device 250 for the mixing device 1 are brought together in a program switching device or a control device 280 (FIG. 4) such that prior to commencement of the mixing process, in other words prior to feeding-in the binder component A and the hardener components B, B1 and actuation of the hydraulic cylinder or of the piston rod for the storage container 90 for the binder component A and for the two storage containers 91, 92 for the hardener components B, B1, the drive device 270 for the third storage container 92′ for the hardener component B2 is operated independently of all other functions, so that prior to commencement of the actual mixing process a fore-run of hardener component B2 takes place for approximately 1 second, wherein after commencement of the rotary movement of the rotor part 19 of the mixing device 1 the third drive device 270 for the third storage container 92′ for the hardener component B2 is operated with an after-run of 1 second for the further supply of hardener component B2, wherein in the case of complete discharge of the third storage container 92′ for the hardener component B2 a toothed rack, driven by the third drive device 270 that is arranged in a box-like container 285 on the supporting plate 101, reaches the lower region of the third storage container 92′ for the hardener component B2. The toothed rack (not shown in the drawing), which continues to move downwards, lifts the box-like container 285, which is attached on one side to the transverse brace 108 by means of a hinge, such that the box-like container 285 is lifted by approximately 2 mm, wherein by way of this movement of the box-like container 285 a visual signalling device 290 is operated, and for exchanging the empty third storage container 92′ for the hardener component B2 for a full storage container with the hardener component B2 the entire device 100 is made inoperative.

On its wall surface 235c opposite the nozzle stubs 231, 232, 232′, the formed piece 235 of the catch container 230 comprises a nozzle stub 234 which, for holding and centring the catch container 230, is engaged with the handle or the clamping device 103 of the device 100 and with the drive shaft of the drive device 250 suited for the mixing device 1.

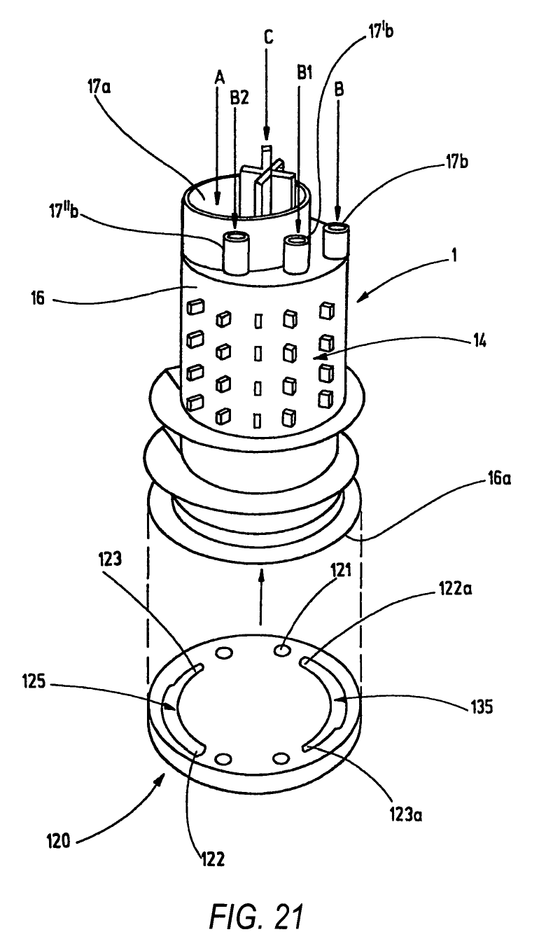

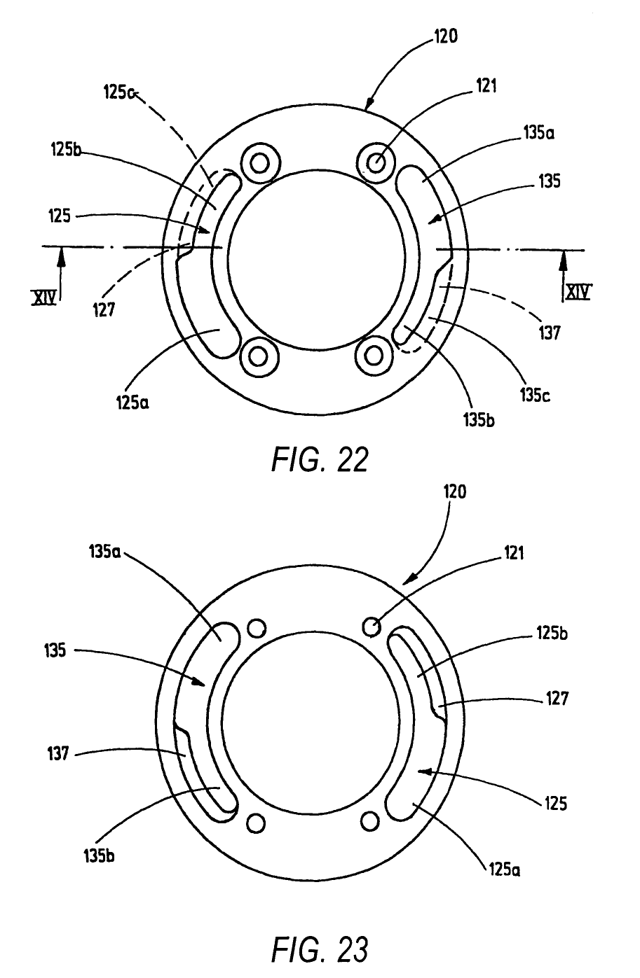

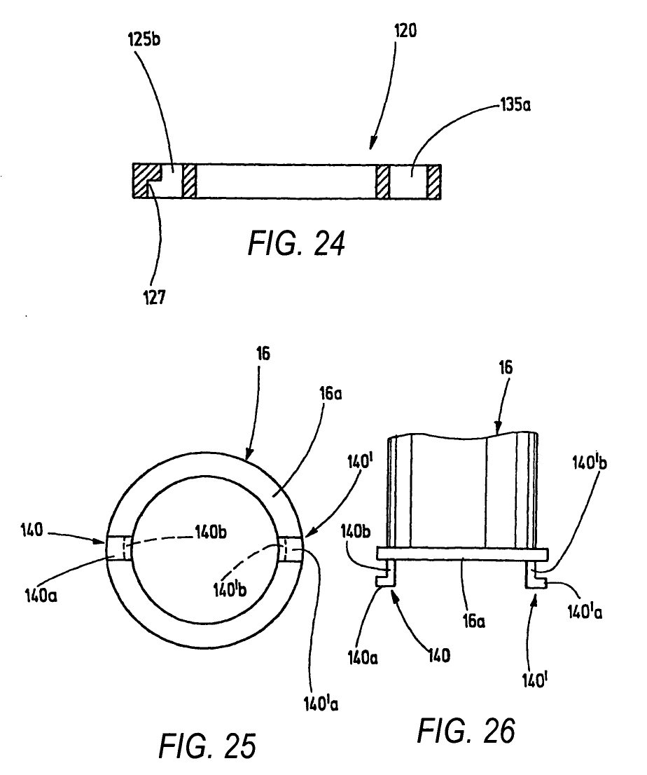

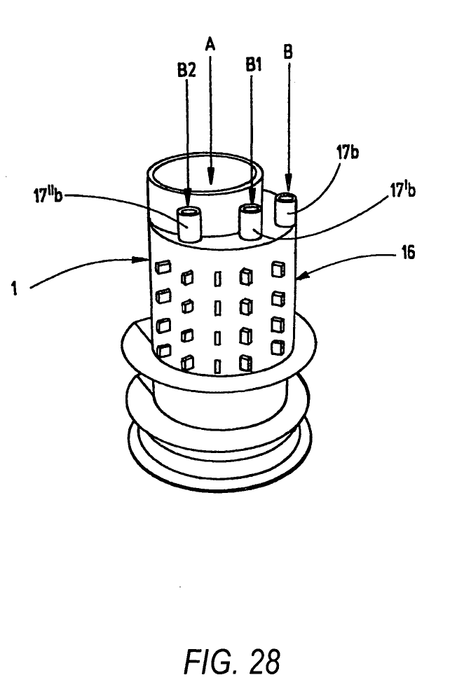

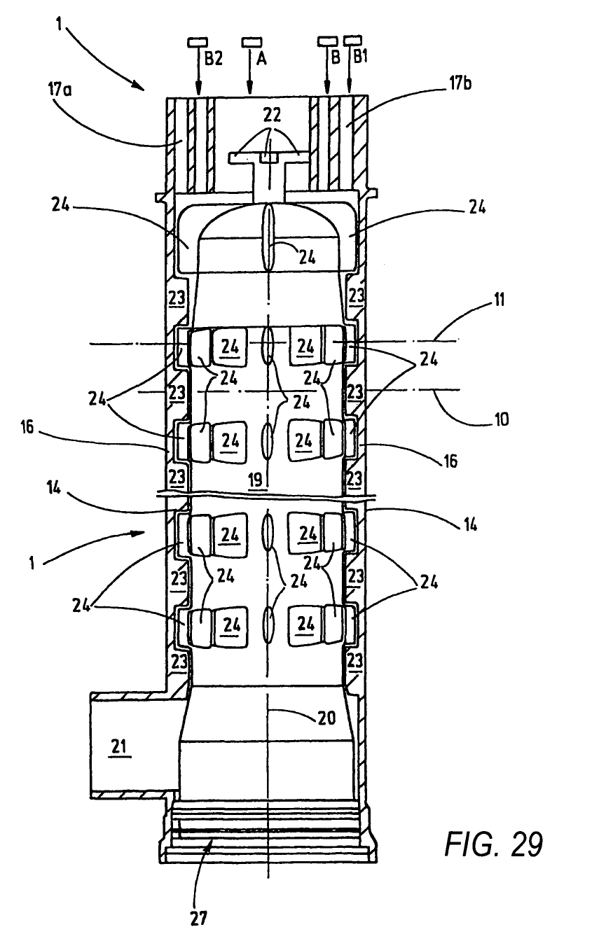

The mixing device 1 shown in FIGS. 21 to 34 comprises a stator part 16 and a rotor part 19. The rotor part 19 is inserted in the stator part 16 and is rotatably held in said stator part 16. The drive for the rotor part 19 acts on C (FIGS. 21 and 27). For the purpose of supplying the mix and also the hardener component B2 for the fore-run and after-run, the stator part 16 comprises inlets or inlet nozzles 17a, 17b, 17′b, 17″b, wherein the binder component A is fed in through the inlet 17a, while the hardener components B, B1, B2 are fed in through the inlets 17b, 17′b, 17″b. To illustrate the supply of the components, respective arrows are designated A, B, B1, B2. The rotor part 19 is rotatably held on a longitudinal axis 20, wherein projections 22 are provided on the end at the rotor part 19, which projections 22 rotate together with the rotor part 19 and extend into the inlet 17a. This results in an increase in the flowability of the thixotropic binder component A, wherein multiple projections have been provided towards the end of the rotor part 19.

According to FIGS. 21, 22, 23, 24, 25 and 26, attachment and mounting of the mixing device 1 to the holding device 103 of the base 101 of the device 100 takes place by means of a ring-shaped holding device 120. To this effect the stator part 16, at its end 16a facing away from the inlets 17a, 17b, 17′b, comprises the ring-shaped holding device 120 that comprises attachment openings 121 and that is detachably connected to the stator part 16 so as to be rotatable in the manner of a bayonet-type locking arrangement, wherein the rotatability of the mixing device is limited in such a way, by means of end stops 122, 123; 122a, 123a, that a fit of the inlet 17a for the binder component A with the infeed device of the binder component A is achieved, and at the same time a fit of the inlets 17b, 17′b, 17″b for the hardener components B, B1, B2 with the infeed devices for the hardener components B, B1, B2 is achieved.

This ring-shaped holding device 120 comprises two opposing slot-shaped openings 125, 135 that extend in a curved shape, of which slot-shaped openings 125, 135 each comprises two guide sections 125a, 125b, 135a, 135b of different width, of which the respectively wider guide section 125a, 135a is designed for inserting one of two L-shaped guide cams 140, 140′ that are formed to the lower circumferential edge 16a of the stator part 16, wherein the width of the wider guide section 125a, 135a corresponds to the length of the free angled limb 140a, 140′a of the guide cam 125, 135, and of which guide sections the respective narrower guide section 125b, 135b comprises a width that corresponds to the thickness of the limb 140b, 140′b of the L-shaped guide cam 140, 140′, which limb 140b, 140′b has been formed to the lower circumferential edge 16a of the stator part 16 and extends parallel to the longitudinal direction of the mixing device 1.

The respective outer wall region 125c, 135c of the narrower guide section 125b, 135b comprises web-like wall sections 125d, 135d while forming tongue-like edge regions 127, 137 so that groove-like recesses are formed whose depth approximately corresponds to the thickness of the angled limb 140a, 140′a of the L-shaped guide cam 140, 140′ (FIG. 21).

The ring-shaped holding device 120 comprises plastic or some other suitable material, e.g. metal.

The ring-shaped holding device 120 is used as follows: the ring-shaped holding device 120 is attached to the holding device 103 of the supporting plate 101 of the device 100 such that the slot-shaped openings 125, 135 with their wider guide sections 125a, 135a and with their narrower guide sections 125b, 135b face the mixing device 1 (FIG. 21). After attachment of the ring-shaped holding device 120, the mixing device 1 is placed onto the holding device 120 such that the L-shaped guide cams 140, 140′ of the mixing device 1 are led through the wider guide sections 125a, 135a of the slot-shaped openings 125, 135 (FIG. 26). Thereafter, the mixing device 1 is rotated on its longitudinal axis until the free limbs 140a, 140′ of the L-shaped guide cams 140, 140′ contact the ends of the narrower guide sections 125b, 135b of the slot-shaped openings 125, 135. In this process the free limbs 140a, 140′a of the L-shaped guide cam 140, 140′ grip the tongue-like edge regions 127, 137 of the narrower guide sections 125b, 135b that extend adjacent to the circumferential edge of the ring-shaped holding device 120 (FIG. 12). The mixing device 1 is thus held in the manner of a bayonet-type locking arrangement to the ring-shaped holding device 120 and thus to the holding device 103 of the base 101 of the device 100. When the mixing device 1 is rotated in the opposite direction, the bayonet-type locking arrangement is released, and the mixing device 1 can be removed from the device 100 so that a used mixing device 1 can be exchanged for a new mixing device. With the way the mixing device 1 is held to the device 100, a situation is achieved in that after insertion of the mixing device 1 into the ring-shaped holding device 120, rotatability of the mixing device 1 is limited in such a manner, by means of the end stops 122, 123, 122a, 123a at the ends of the slot-shaped openings 125, 135 of the ring-shaped holding device 120, 130, that a fit of the inlet 17a for the binder component A with the infeed device for the binder component A is achieved, and at the same time a fit of the inlets 17b, 17′b, 17″b for the hardener component B, B1, B2 with the infeed devices for the hardener components B, B1, B2 is achieved (FIG. 21).

By means of the projections 22 at the end of the rotor part 19, kinetic energy is introduced into the binder component A in order to reversibly destroy its thixotropy; consequently the binder component A can then more evenly mix with the two hardener components B and B1 when it enters a downstream mixing chamber 14. The mixing chamber 14 is formed in the manner of a ring-shaped gap between the rotor part 19 and the stator part 16. The components A, B and B1 to be mixed are fed to the mixing device 1 such that they combine only in the interior of the mixing chamber 14 after hardener component B2 has already been fed into the mixing chamber 14 by means of the fore-run with the subsequent after-run. As a result of this, after completion of the mixing process and after separation of the mixing device 1 from a corresponding base station, all the remnants of mix remain in the mixing device 1. Said mixing device 1 is designed as a throw-away article which after use is disposed of and replaced by a corresponding new part. By way of the inlets 17b, 17′b, 17″b the hardener components B, B1, B2 are fed into the mixing chamber 14, in which the hardener components are mixed with the binder component A. In this arrangement the infeed of the components A, B and B1 takes place in the following sequence: first of all, prior to commencement of the actual mixing process, for approximately one second hardener component B2 is fed, as fore-run, from the storage container 92′ to the mixing device 1, in which there is not yet any binder component A nor are there any further hardener components. After the rotor part 19 has commenced rotating, after-run of the hardener component B2 takes places for one more second, while at the same time the required quantities of binder component A and hardener components B and B1 are fed in from the storage containers 90, 91, 92. The infeed of the hardener component B2 only takes place for the fore-run and the after-run.

Thereafter a small quantity of hardener component B is fed to the mixing chamber 14. At the same time the binder component A and the hardener component B1 are fed in so that the binder component A that reaches the mixing chamber adjoins the hardener component B or B2, which is already present in the mixing chamber, where it mixes with the aforesaid. This approach results in binder component A that flows into the mixing chamber adjoining the already present hardener component B or B2 and becoming mixed with it so that no portion of binder component can issue that does not have a hardener component. This is associated with a particular advantage in that hardener component B2 from the storage container 92′ is already in the mixing chamber 14 as a result of the fore-run provided, so that introduced binder component A meets the hardener component B2 when it flows into the mixing chamber 14. Thus there is always binder component that is mixed with hardener component that emerges from the mixing chamber, so that even the mixture that first emerges contains a hardener component and can be processed immediately. Thereafter, hardener component is fed to the mixing chamber 14 before the binder component flows into the mixing chamber. This fore-run of hardener component is achieved by means of control-technology in that corresponding control of the metering devices 90, 91, 92, 92′ for the hardener components and for the binder component takes place (FIG. 16). Furthermore, the stator part 16 of the mixing device 1 can also comprise only one infeed device for the hardener component. In this case, by way of the control system, first there is an infeed of a small quantity of hardener component B2 as a fore-run and after-run, this is followed by the infeed of a small quantity of hardener components into the mixing chamber 14, after which the infeed of the binder component takes place, namely together with further hardener components. Only the hardener component for the fore-run and the after-run are taken from the storage container 92′ so that already prior to feeding-in the binder component a very small quantity of hardener component is present in the mixing chamber 14, so that when binder component reaches the mixing chamber 14 it already adjoins hardener component that has been introduced by the fore-run, and in order to create a smooth transition the infeed of a small quantity of hardener component takes place, after which a further infeed of hardener component and binder component takes place. It is also possible, instead of taking hardener components from two storage containers, for the fore-run and after-run to take hardener component only from one of the two storage containers for the hardener component. However, it is more advantageous if two storage containers are provided for the hardener component, and a separate storage container with hardener component is provided for the fore-run and the after-run.

By means of metering devices that are preferably arranged upstream, the components to be mixed are continuously conveyed through the mixing chamber 14 to a dispensing opening 21 that is arranged on the stator part 16, which dispensing opening is arranged downstream of the inlets 17a, 17b and 17′b and downstream of the mixing chamber 14. On the stator part 16 several first mixing teeth 23 are arranged, which extend radially inwards into the mixing chamber 14, whereas on the rotor part 19 second mixing teeth 24 are arranged, which extend radially outwards into the mixing chamber 14.

By means of rotational movement of the rotor part 19 in the stator part 16 the mixing teeth 23, 24 are thus moved against each other so that mixing of the two components A, B and B1 takes place. If a fore-run of the hardener component has already taken place, and part of the subsequent binder component A has mixed with the hardener component B, the two other components A and B are fed to the mixing chamber. Thereafter, in the mixing chamber 14, the fed-in binder component A and hardener component B, B1 are intermixed. These two components A and B, B1 are fed into the mixing chamber at a predetermined ratio until the respective desired quantity of mix has been obtained. The first mixing teeth 23 are arranged on a first mixing tooth plane 10, while the second mixing teeth 24 are arranged on a second mixing tooth plane 11. In total, five first mixing tooth planes 10 and four second mixing tooth planes 11 are provided, which are arranged alternately, so as to be interleafed, in axial direction along the longitudinal axis 20. As a result of the rotary movement of the rotor part 19, the second mixing teeth 24 radially rotate in the gaps of the first mixing teeth 23 that are shaped on the stator part 16 so as to be at rest. As a result of this a shear movement or dividing movement is generated between the mixing teeth 23 and 24 so that the mix undergoes optimum mixing.

Preliminary mixing of the two components A, B and/or B1 takes place by larger, second, mixing teeth 24 that are arranged on the front end of the rotor part 19 so that these components are pre-mixed through this mixing tooth plane. The larger, second, mixing teeth 24, which are arranged towards the end, are arranged fourfold on the circumference of the rotor part 19; they make a transition to the projections 22 that are also present fourfold. At the open end the stator part 16 comprises a receiving opening in which a cylindrical bearing section 27, which has been formed to the rotor part 19, causes the rotor part 19 to be held in the stator part 16. This creates a radial bearing arrangement of the rotor part 19 in the stator part 16. The diametric fit of the cylindrical bearing section 27 on the rotor part 19 is dimensioned such that a corresponding slide bearing arrangement is created.

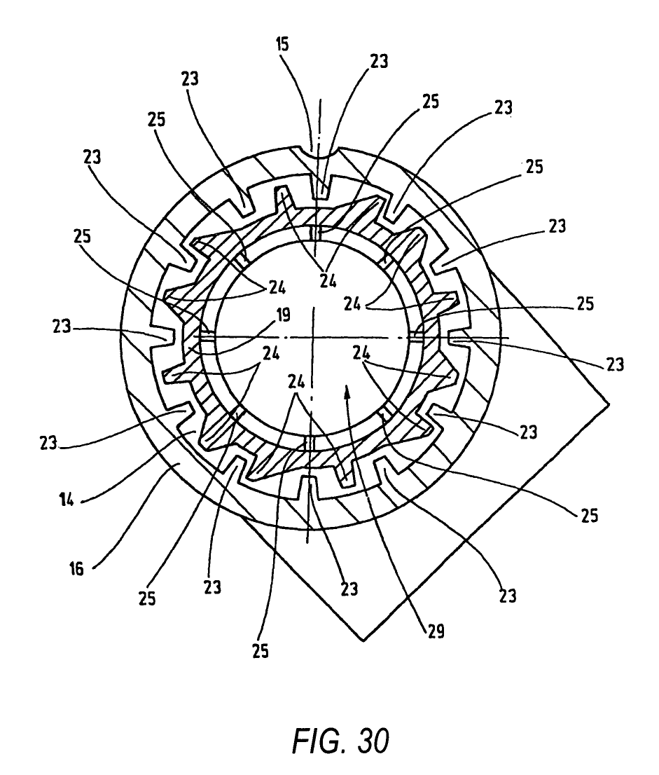

FIG. 30 shows a cross section of the mixing device 1, wherein both the stator part 16 and the rotor part 19 are shown in cross section. The diagram illustrates in particular the arrangement of the mixing teeth 23 and 24, wherein the second mixing teeth 24 are moulded to the rotor part 19 such that, as far as the production of the rotor part 19 with the use of injection-moulding is concerned, a single mould joint is sufficient for applying a single column injection moulding tool. The diagram further shows that the mixing teeth 23, 24 are formed to the stator part 16 or to the rotor part 19 with the use of uniform material so that the mixing device 1 only comprises these two components. The rotor part 19 comprises an inner region which, being a recess 29, is hollow. Catch ribs 25 extend radially inward into the recess 29, wherein a total of eight catch ribs 25 are arranged on the circumference. The stator part 16 comprises a crescent-shaped catch contour 15 that is provided on the outer circumference.

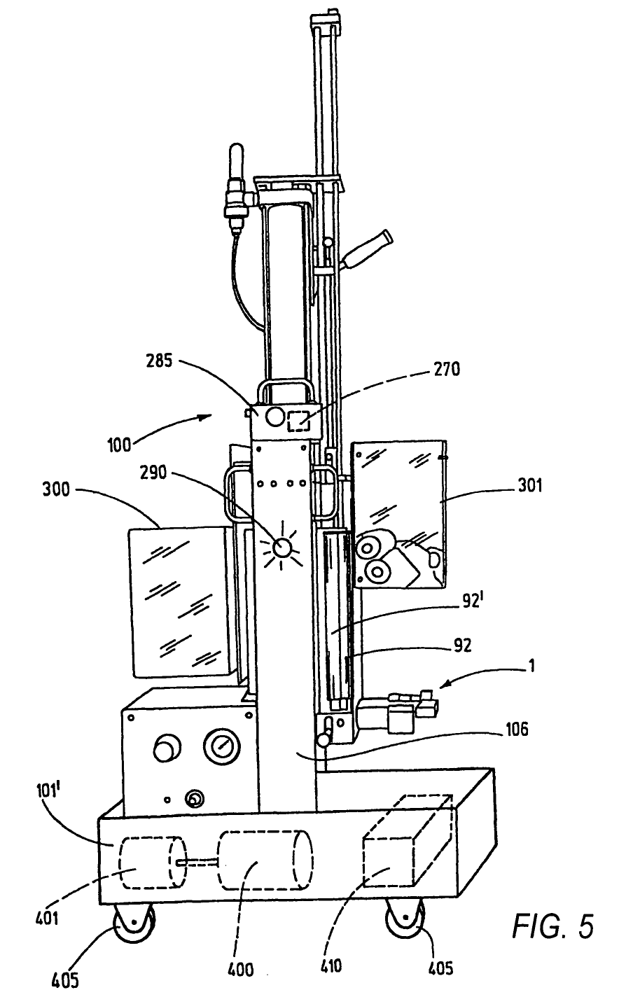

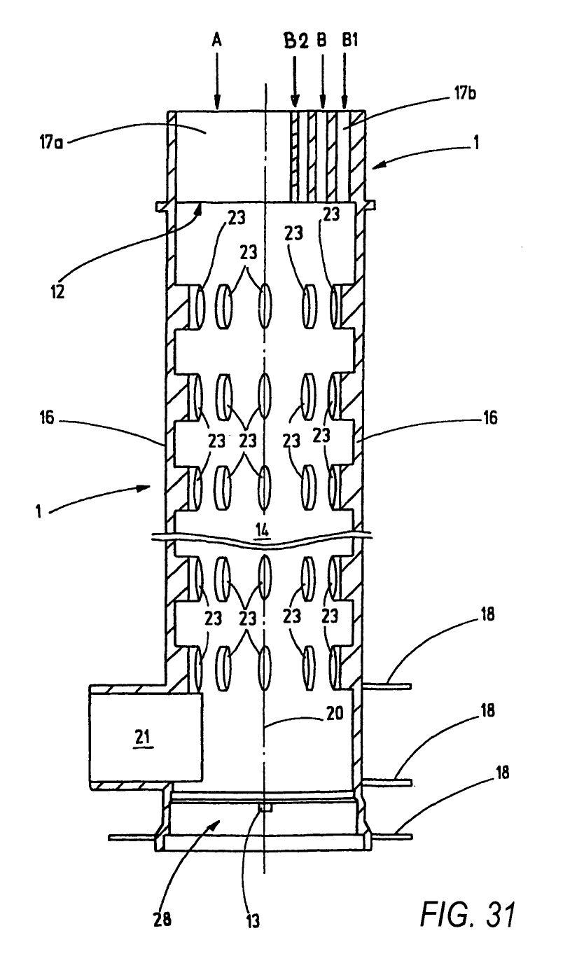

FIG. 31 illustrates a cross section of the stator part 16, shown in a section view along the longitudinal axis 20. Thus the arrangements of the inlets 17a, 17b, 17′b that lead directly into the mixing chamber 14 are shown in section view. On the inside in the wall of the stator part 16 the first mixing teeth 23 are arranged on the total of five planes, wherein in total twelve first mixing teeth 23 are provided, circumferentially spaced apart on one mixing tooth plane each. At the end of the mixing chamber 14, which end is opposite the inlets 17a, 17b and 17′b, a dispensing opening 21 is provided which delivers the mix radially outwards from the mixing chamber 14 (FIG. 5). The outer circumference of the stator part 16 comprises plate-shaped formed parts 18, wherein in total three plate-shaped formed parts 18 are provided at the height of the dispensing opening 21 and on the end on the stator part 16. At the height of a support bearing area 12 the inlet 17a or 17b makes a transition to the mixing chamber 14, wherein the support bearing area 12 forms an axial bearing arrangement of the rotor part 19 (not shown). At the rear end, which is opposite the inlets 17a, 17b, 17′b, 17″b, the stator part 16 is open at the end so that the rotor part 19 can be joined to the stator part 16 through this opening. In the region of the opening the stator part 16 comprises a hollow space 28, designed as a section, in order to receive the mix which moves into this region. In order to allow the mix to exit when appropriate, the wall comprises outlets 13, of which in total two are arranged on the circumference.

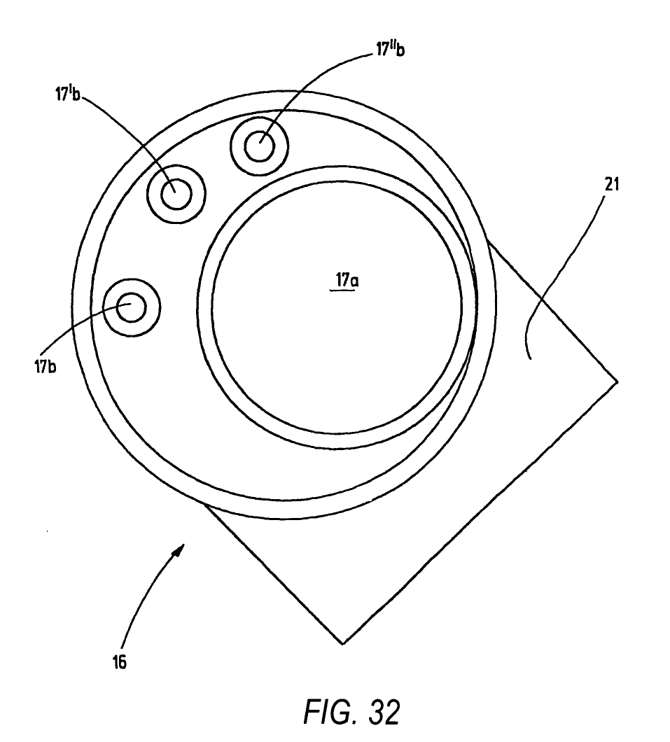

FIG. 32 shows a top view of the stator part 16, wherein in particular the arrangement of the inlets 17a, 17b, 17′b is shown. The inlet 17a is eccentric in design and comprises a circular cross section. Apart from the inlet 17a, two inlets 17b, 17′b are provided in order to allow a redundant supply of the hardener component into the mixing chamber 14. In this arrangement the inlets 17b, 17′b, 17″b are designed so as to be spaced apart from each other; they are fed by way of feed lines and metering devices 91, 92 that are also separate from each other. Furthermore, the diagram shows the arrangement of the dispensing opening 21, which conveys the mix laterally out of the stator part 16.

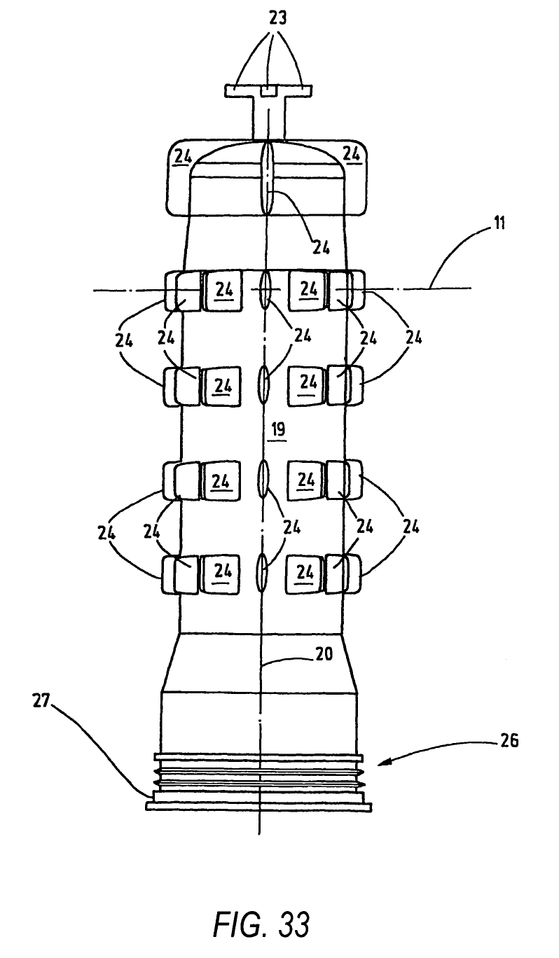

FIG. 33 shows the rotor part 19, wherein in particular the second mixing teeth 24 are shown as far as their distribution on the circumference of the rotor part 19 is concerned. In total twelve mixing teeth are provided on a mixing tooth plane 11, so that with a total of four mixing tooth planes 11 a total of 48 mixing teeth are arranged on the rotor part 19. In addition, on the upper part of the rotor part 19 there are four further mixing teeth 24 for premixing the mix. They make a transition to the projections 22, which are also arranged fourfold on a type of extension of the rotor part 19.

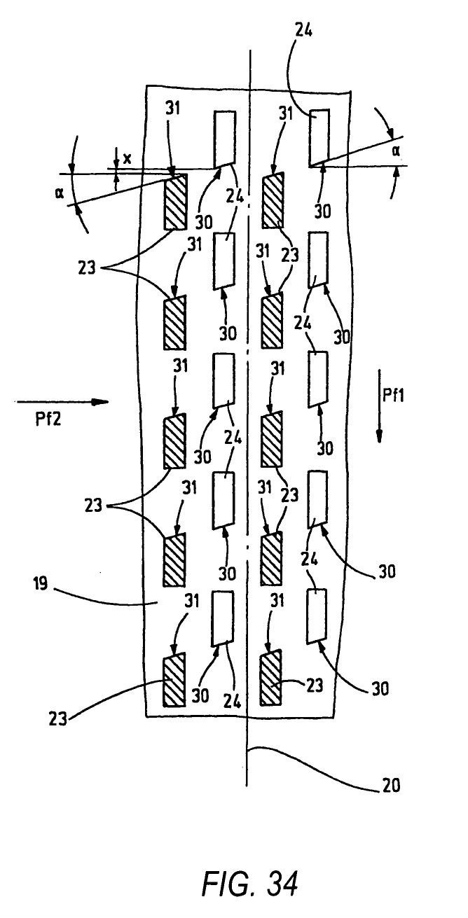

FIG. 34 illustrates a partial cross section of the mixing device 1 along the ring-shaped circumferential mixing zone, wherein the mixing teeth 23 of the stator part 16 are shown hatched in the diagram, while the mixing teeth 24 of the rotor part 19 are shown non-hatched. The mixing teeth 23 and 24 of the individual mixing tooth planes are arranged so as to be spaced apart from each other such that the teeth comprise gaps relative to each other. Between the individual mixing tooth planes the mixing teeth 23, 24 comprise gaps through which the mixing teeth that are opposite the respective gap run during the rotational movement. By a continuous infeed of the components A, B into the mixing chamber 14, a division of the mix flow takes place, i.e. one part of the mix flow flows on one side of the respective tooth 23, 24, while the other part flows past the other side of the respective tooth 23, 24. Since this division takes place in several stages that correspond to the number of levels or mixing tooth planes, the mix is intensively mixed.

The mixing teeth 23 comprise facing areas 31 that are opposite the facing areas 30 that are formed to the second mixing teeth 24. During contact of the mixing teeth 23 and 24 it is thus possible for sliding to occur without there being any removal of material from the mixing teeth. This can take place in particular when the rotor part 19 is offset by an amount x in relation to the stator part 16 so that the mixing teeth 23, 24 meet each other. The facing areas 30, 31 are bevelled at an angle α, wherein said angle α is preferably 15°.

For operating the device 100, from a process point of view, the approach is such that the piston rods 110, 111, 112, 112′ with the piston plates 240, 241, 242, 242′ are inserted manually into the opened storage containers 90, 91, 92, and as soon as the piston plates come to rest below the opening edges of the storage containers 90, 91, 92, 92′ the drive device 270 for the hydraulics for actuating the piston rod 245′ for the storage container 92′ for the hardener component B2 is operated so that the fore-run for the hardener component B2 can be initiated. As soon as the fore-run of the hardener component B2 has been initiated, the motor 102 for the hydraulics for actuating the piston rods 110, 111, 112 for the storage containers 90, 91, 92 for the binder component A and for the hardener component B, B1 is operated, wherein at the same time the after-run for the hardener component is initiated; only then are the individual mixing processes carried out. This measure prevents injuries caused when fingers of the hand of an operator come to rest in the region of the opening edge, in particular of the storage container 90 for the binder component A, and thus become jammed as a result of the piston plate that is moved at relatively high pressure in the direction of the container.

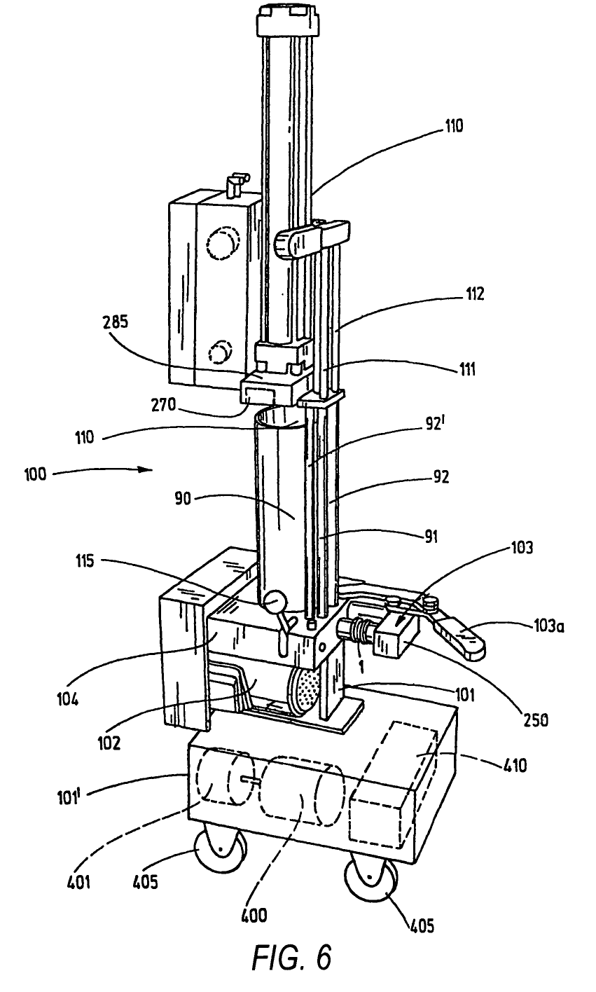

The nozzle-stub-like lead-in openings 17a, 17b, 17′b, 17″b of the mixing device 1 are inserted into the outlets 201, 202, 203, 203′ of the filling head 104 when the device 1 commences operation (FIGS. 6 and 21). At this point the holding device 103 is opened, the lead-in openings 17a, 17b, 17′b, 17″b of the mixing device 1 are inserted into the outlets 201, 202, 203, 203′ of the filling head 104, and the holding device 103 is closed, wherein at the same time a connection of the rotor part 19 with the drive motor 250 provided on the holding device 103 is established (FIG. 6).

In order to facilitate exchange of the storage containers, and in order to achieve equalisation of the fill heights in the storage containers, because said fill heights differ between the binder component A and the hardener components B, B1, to remove the overfill of the storage containers 91, 92 for the hardener component B, B1, the catch container 230 is provided, which at commencement of drawing off the components A, B, B1 from their storage containers 90, 91, 92 is inserted into the device 100 instead of the mixing device 1.

The formed piece 235 of the catch container 230 comprises a plastic or some suitable material.

Handling of the catch container 230 is as follows:

After insertion of a new storage container 90 for the binder component A and of the new storage containers 91, 92 for the hardener components B, B1 into the device 100 (FIG. 16), the catch container 230 is inserted into the holding device 103 (FIG. 6), wherein the nozzle stubs 231, 232 of said catch container 230 are inserted into the outlets 202, 203 of the feed channels 205, 206 of the filling head 104, by way of which feed channels 205, 206 the binder components B, B1 are fed in (FIGS. 13 and 16). After insertion of the catch container 230 into the filling head 104, a handle 260 that is connected to the piston rods 110, 111, 112 of the storage containers 90, 91, 92 for the binder component A and the hardener component B, B1 is pulled with full force in the direction of the arrow X i.e. in the direction of the base 101 of the device 100 (FIG. 1) so that the piston rods 110, 111, 112 are moved in the direction of the arrows x1, x2, x3 (FIG. 17) until the plate-shaped pistons 240, 241, 242 impinge upon the surfaces 0B, 0B1, 0B2 of the components A, B, B1 of the storage containers 90, 91, 92. Pulling on the handle 260 is then increased with the result that the contents of the storage containers 91, 92 for the hardener components B, B1 are pushed in the direction of the arrows x4, x5 until the overfill in the two storage containers 91, 92 for the hardener components B, B1 is pressed out of the storage containers 91, 92 and pressed into the catch container 230 (FIG. 18). With this, equalisation of the fill heights in the three storage containers 90, 91, 92 is achieved, i.e. the fill heights in the storage containers 91, 92 have then reached the fill height in the storage container 90, because due to the greater viscosity of the binder component A when compared to the viscosity of the hardener component B, B1, the binder component A is not pressed from its storage container 90 during the pressing out of the quantity of hardener component B, B1 from its storage containers 91, 92.

When the fill heights in all three storage containers 90, 91, 92 have been equalised (FIG. 18) the catch container 230 that contains the quantity of hardener component B, B1, which quantity accounts for the overfill, is drawn off from the filling head 104 and disposed of (FIG. 18). After the catch container 230 has been pulled from the filling head 104, the mixing device 1 is placed on said filling head 104, in that the nozzle-stub-like inlets 17a, 17b, 17′b of the mixing device 1 are inserted into the outlets 201, 202, 203 of the feed channels 204, 205, 206 in the filling head 104 (FIG. 17). The arrangement of the outlets 202, 203 for the hardener component B, B1 in the filling head 104 and the arrangement of the nozzle-stub-like inlets 17b, 17′b of the mixing device 1, as well as those of the nozzle stubs 231, 232 of the catch container 230, is such that both the nozzle-stub-like inlets 17b, 17′b of the mixing device 1 and the nozzle stubs 231, 232 of the catch container 230 can be inserted into the outlets 202, 203 for the hardener component B, B1 in the filling head 104. Furthermore, the arrangement of the outlet 201 for the binder component A in the filling head 104 is such that the nozzle-stub-like inlet 17a of the mixing device 1 for the binder component A can communicate with the outlet 201 for the binder component A in the filling head 104 (FIG. 13).

With the use of the device 100 according to the invention with a mixing device 1 and a catch container 230 a ready-to-use filler material for the filling of surfaces, for example of vehicle bodywork, by mixing a binder component A with hardener components B, B1, B2 to form a pasty or liquid mix is produced in such a manner that prior to commencement of drawing off a mixed quantity of binder component A and hardener component B, B1 for equalisation of the surface height of the binder component A in its storage container 90 and of the hardener components B, B1 in their two storage containers 91, 92, the fill height of the hardener components B, B1 in the two storage containers 91, 92 is set higher in relation to the fill height of the binder component A in the storage container 90; thereafter by manual operation the piston rods 110, 111, 112 that are arranged in the interior spaces 90a, 91a, 92a, which piston rods 110, 111, 112 at their free ends bear plate-shaped pistons 240, 241, 242, are manually moved, in the storage containers 90, 91, 92, against the container contents while at the same time impinging on the binder component A in the storage container 90 and the hardener components B, B1 in the storage container 91, 92, and the overfilled quantity of hardener components B, B1 from the storage containers 91, 92 are pressed into the catch container 230 inserted into the device 1 until the same fill heights of binder component A and of hardener components B, B1 have been reached, whereupon the catch container 230 is exchanged for the mixing device 1, and subsequently all the piston rods 110, 111, 112 are actuated by means of motor-driven or hydraulic force, in order to press the quantities of binder component A and of hardener component B, B1, which quantities are required for producing the mix, from the storage containers 90, 91, 92 into the mixing device 1 for mixing the components A, B, B1, wherein the feature, according to which prior to commencement of the actual mixing device 1 hardener component B2 is removed from an additional storage container 92′ and is fed as fore-run and as after-run to the mixing chamber 14 of the mixing device 1, is, or can be, incorporated in the method-related process.

The load-bearing structure of the device comprises a transparent protective cover 200, which is to be opened, for covering the storage containers 90, 91, 92, 92′, wherein a protective switch is provided that is in effective connection with the protective cover 200 and the device 100, which protective switch turns the device off when the protective cover is open, which protective cover comprises a transparent plastic or some other suitable material, wherein said protective cover is designed in a door-like manner (FIG. 2).

Furthermore, the load-bearing structure of the device 100 comprises front and/or rear receptacles 300, 301 for receiving spent or new mixing devices 1 (FIGS. 4 and 5).

Apart from the optical signalling device 290, on the load-bearing structure of the device 100, visibly a further visual signalling device 350, connected to a source of current, for example a signal light 351 emitting white light or coloured light, and/or an acoustic signalling device 360, such as a signal horn or siren 361, can be arranged, wherein both signalling devices 350, 360 during start-up of the device 100, for a predetermined period of time, preferably for a period of two or three minutes, can be activated by lighting and/or signalling. The signalling device 360 can also be activated in the case of a display indicating that the storage container 92′ for the hardener component B2 is empty (FIG. 1).

The supporting plate 101 that receives the device 100 is designed to be movable, and to this effect comprises rollers 405 (FIGS. 2, 3, 4). Insofar as the drive devices for the piston rods for the storage containers 90, 91, 92, 92′ are hydraulically actuated, a compressor 400, preferably a mini compressor, is arranged on the supporting plate 101, by means of which compressor the compressed air is generated that is required for actuating the hydraulic cylinders 110, 111, 112, 112′ that are connected to the piston rods. The compressor 400 comprises a container 401, which preferably comprises at least 20 litres of air that is subjected to pressure of at least 20 bar.

Insofar as electric-motor-driven drive devices for the piston rods of the storage containers 90, 91, 92, 92′ and for operating the rotor part 19 of the mixing device 1 as well as for operating the drive device 270 for the toothed rack for switching the device 100 on or off are provided, on the supporting plate 101 a source 410 of current is arranged, e.g. in the form of a rechargeable battery, preferably one or several motor vehicle batteries, which can be connected to a transformer.

The supporting plate 101 can also be designed as a housing 101′. On the supporting plate or in the housing a compressed-air container 401 with a capacity of 25 litres or 50 litres or of larger quantities of compressed air, and/or a source 410 of current are/is arranged (FIGS. 1, 2, 3, 4, 5, 6 and 7). Preferably a rechargeable battery for 24-volt operation is used as a source 410 of current. In order to generate the required compressed air, the compressed-air container 401 can also be connected to a compressor 400. As a result of the possibility of storing compressed air in the compressed-air container 401, compressed air is available at any time for operating the device 100.

In order to be able to move the device 100, the supporting plate 101, which can also be designed as a housing 101′, can comprise rollers 405 (FIGS. 2, 3, 4, 5, 6 and 7). For manual movement of the device the supporting plate 101 or the housing 101′ or the device 100 itself comprises a bar-like handle 406 (FIG. 2). For motor-driven movement of the device 100 on the supporting plate 101 or on the housing 101′ a drive motor 408 is provided, which is fed by the current source 401 (FIG. 1). By way of on and off switches and a speed control device (not shown in the drawing) movement of the device is controllable. In the mobile design of the device 100 the storage containers 90, 91, 92, 92′ are positioned on the filling head 104 of the device in a non-slip and fixed manner.

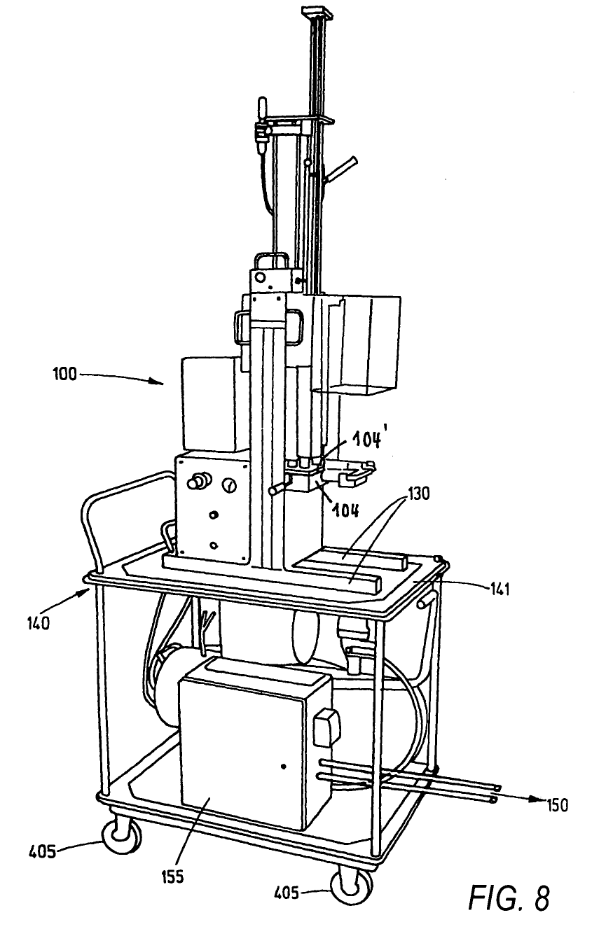

According to FIG. 8, a further possibility of providing mobility for the device consists of the device 100 to be designed as a floor-model device comprising a base plate or an H-shaped base 130, wherein in order to move the device 100 it is arranged and held on a transport table 140 comprising rollers 405, which transport table comprises a top supporting plate 141 as a base- and attachment surface for the device 100, and a further, shelf-like, supporting plate 142 that receives the container 401 that contains compressed air, the compressed-air generator and/or a source 410 of current, preferably a rechargeable battery and/or a drive motor 408, to provide mobility for the device 100. The rechargeable battery, which is used as a source of current, is preferably designed for 24-volt operation.

On days where the temperature is particularly high it can happen that, due to excessive heat, gelling of the two reaction components A and B takes place very quickly so that the time available for filling the filler material obtained is too short, so that gelling takes place already within 2 minutes. It is thus necessary for the time available for filling to be extended, preferably to 3 to 4 minutes. This is achievable by cooling the binder component A.

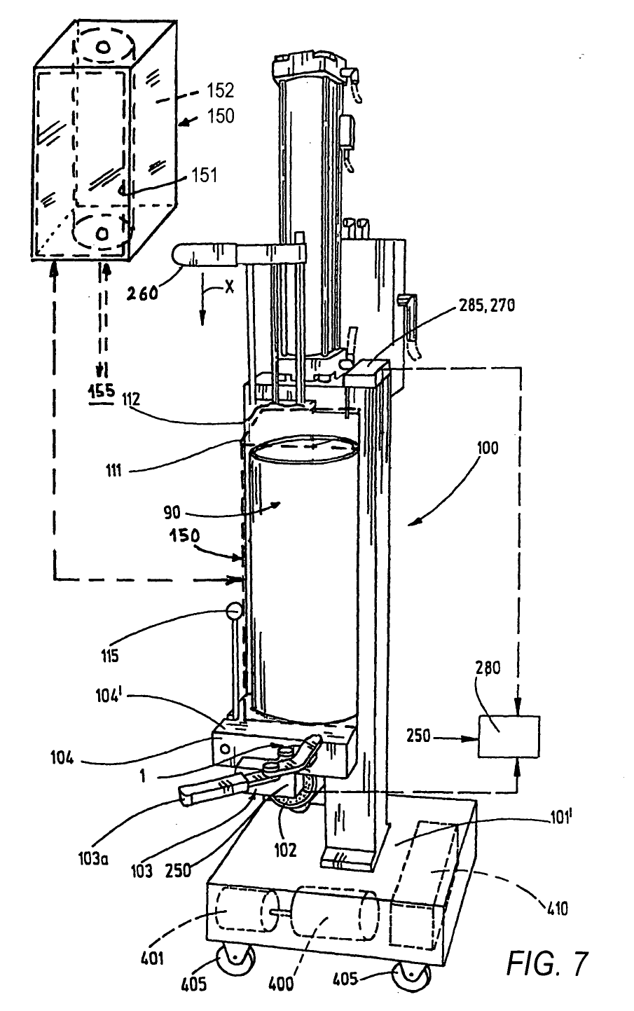

In order to extend the pot life of the reaction components, such as hardener components B and binder components A, the storage container 90 comprising the binder component A is arranged in a closed container 150 whose upper region comprises a through-hole through which the piston rod leads in order to be able to move the piston plate that is connected to the free end of the piston rod and that is situated in the interior space of the container 90. This container 150 comprises a closable container insert opening 151 (FIG. 7). On the bottom end the container 150 also comprises an opening that corresponds to the outlet of the container 90. Preferably the container 150 comprises a suitable cold-insulating material.

The interior space 152 of the container 150 is in effective connection with a refrigeration system of a cooling device 155 in order to cool the storage container 90 and the binder component A that is arranged in said storage container 90 at elevated ambient temperatures. Preferably, a Peltier refrigeration system is used for cooling; however, the cooling device 155 is arranged on the base plate or the base 130 of the device 100 or on the mobile transport table 140 (FIGS. 7 and 8). Refrigeration systems designed in some other manner can also be used.

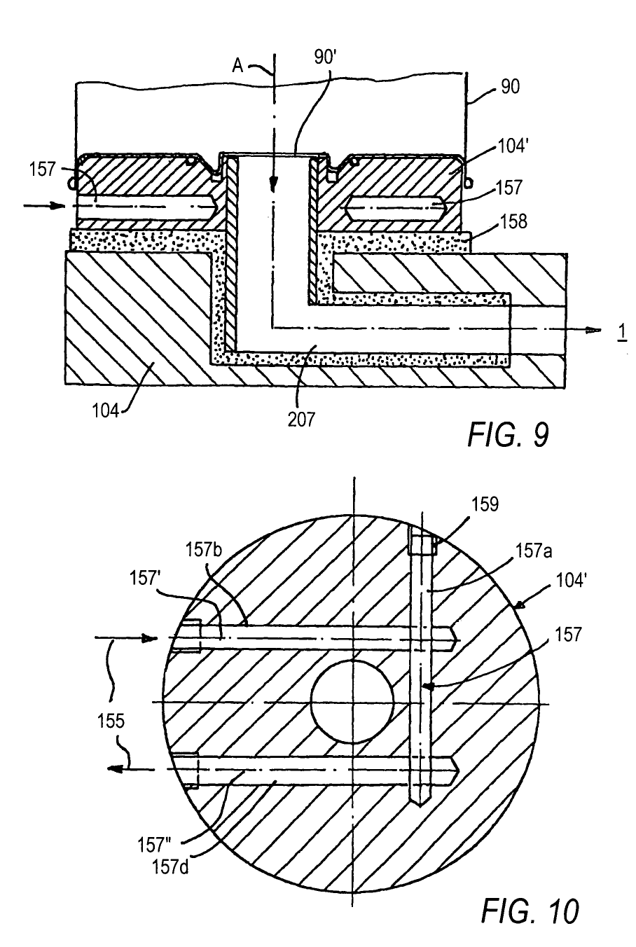

FIGS. 9 and 10 show a further embodiment for cooling the binder component A. According to this embodiment, for cooling the binder component A its storage container 90 is arranged on a support- and base plate 104′ or cold-transport plate 104″, put in place on the filling head 104 of the device 100, which support- and base plate 104′ or cold-transport plate 104″ comprises at least one channel system 157, which is circular or arranged in some other manner, for the infeed and discharge of a coolant, which storage container 90 is connected to a cooling device 155 that is arranged on the base plate or on the base 130 of the device 100 or on the movable transport table 140, wherein a cold-insulation layer 158 is arranged between the support- and base plate 104′ or the cold-transport plate 104″ for the storage container 90 with the channel 157 that carries the coolant on the one hand, and the non-cooled filling head 104 on the other hand. The cold-insulation layer 158 extends into the outlet channel 207 for the binder component A or into the mixing device 1 of the device 100 (FIG. 9).

As shown in FIG. 10, the channel system 157 comprises a feed channel 157′ and a discharge channel 157″. Filling the coolant takes place at 159. The channel section 157a, which interconnects the two channel sections 157b, 157c, comprises a closable opening at 159.

By means of the coolant that has been introduced into the support- and base plate 104′ or the cold-transport plate 104″, the block which forms the support- and base plate 104′, and in particular the base area for the storage container 90 and in particular the region of the binder component A, is cooled or brought to a lower temperature, which block is situated in the bottom region of the storage container 90. For example, if water at a temperature of 10° C. to 12° C. is used as a coolant, then it is already sufficient if the binder component A in the bottom region of the storage container is kept at a temperature of 15° C., as a result of which the pot life is already extended.

Apart from water or some other suitable coolant, cold air can also be used as a coolant. The cooling device 155 is designed in a manner that is known per se. Thermoelectrical cool boxes can also be used.

The support- and base plate 104′ or the cold-transport plate 104″ for the storage container 90 is designed to correspond to the support plate 104′ and ensures safe holding of the storage container 90 on the base plate 156, which comprises corresponding holes so that the binder component A can be fed in for the mixing process of the mixing device 1.

Suitable materials are used as a cold-insulation layer 158 whose task it is to cool the filling head 104 overall, for it is to be the task of the cooling device to cool the support- and base plate 104′ for the storage container 90 so that the container content, in particular in the bottom region of the storage container 90, is cooled down when compared to the warm ambient air, namely to the desired and predetermined temperature. The temperature of the support- and base plate 104′ or of the cold-transport plate 104″ can be measured in predetermined intervals and can be compared to a predetermined temperature value. The temperature of the coolant is then controlled by way of the measuring results obtained so that the support- and base plate 104′ is then at the desired and required temperature.

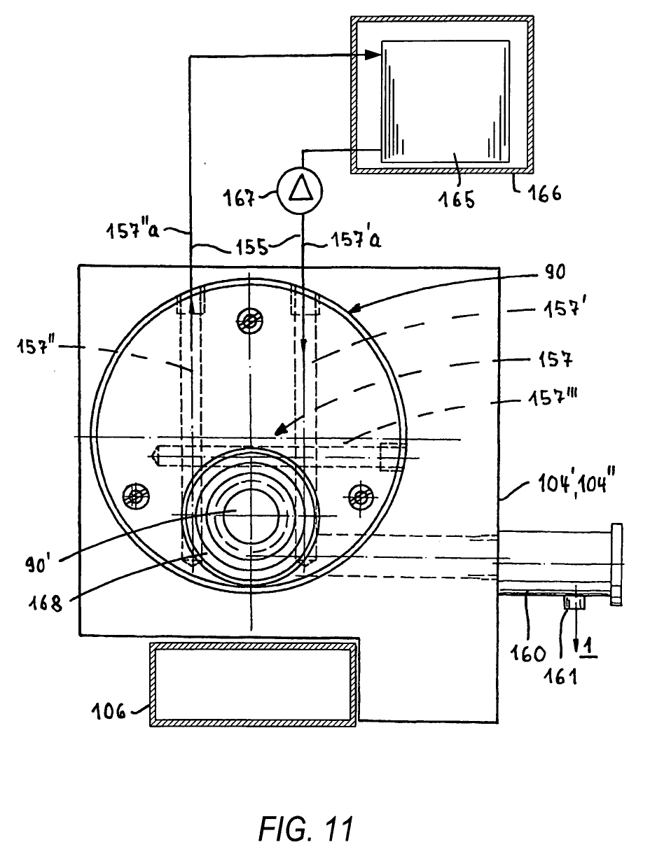

As shown in FIG. 11, the support- and base plate 104′ for the storage container 90 for the binder component A forms a cold-transport plate 104″ which comprises a channel system 157 with a number of channels for the coolant, for example water, which channels are formed in the plate material. This cold transport plate 104″ is cooled by the coolant that flows through the channels, so that the storage container 90 in its bottom region, and preferably in the region of its outlet 90′, and the binder component A that is situated in this region, are cooled or cooled down to the predetermined temperature if the temperature of the binder component A is above the predetermined and required temperature. In order to achieve intensive cooling, the channel system 157 comprises a feed channel 157′ and a discharge channel 157″ that extends parallel to the former, which channels extend over the entire region of the support- and base plate 104′ or of the cold-transport plate 104″, which region is defined by the size of the bottom of the storage container 90, and which channels 157′, 157″ in this embodiment are arranged such that each extends on one side of the outlet 90′ for the binder component A, which outlet is formed in the bottom of the storage container 90. Both channels 157′, 157″ are interconnected by way of a connection channel 157′″, which leads from the support- and base plate 104′ or the cold-transport plate 104″ and is designed so that its end can be closed off so that the channel system 157 can be filled with coolant. It is also possible for the channel system 157 to be provided only in a separate cold-transport plate 104″, which is then placed on the support- and base plate 104′ and connected to it. The storage container 90 is then placed on this cold-transport plate 104″. In the latter the channel system 157 is designed such that the entire plate is cooled, and in particular the region which comprises the outlet 90′ in the bottom plate of the storage container 90. The cold-transport plate 104″ then comprises a hole that coincides with the inlet in the support- and base plate 104′, which communicates with an outlet channel 160 that leads to the outlet 161 for the binder component A in the mixing device 1 (FIG. 11).

According to FIG. 11, a further option of cooling the binder component A consists of the support- and base plate 104′ or the cold-transport plate 104″ on which the storage container 90 for the binder component A is located, which storage container is, for example a metal tin, to be cooled with cooled water. This water is cooled by way of a water container 165 that is situated in a refrigerator 166. By way of a fore-run hose 157′a and a return hose 157″a each, the water container 165 is connected to the two channels 157′, 157″ of the cold-transport plate 104″. A pump 167 is connected in line, in order to be able to feed the cooled water to the cold-transport plate 104″. The cold-transport plate 104″ comprises a downwards-directed metal tube 168. The cold-transport plate 104″ is insulated from the filling head 104 of the device 100 so that cold from the cooled cold-transport plate 104″ cannot be transferred to the filling head 104.

Only at the outlet end of the metal tube 168, i.e. before the binder component A enters the mixing device 1, is there still a small region with binder component A, which region has not yet been completely cooled down and which is thus still warm. In order to reduce the temperature of this region of the binder component A too, it is advantageous if the plastic mixing nozzle of the mixing device 1 is stored in the refrigerator 166. If a mixing nozzle is used that has been pre-cooled in this manner, the part of the binder component A that enters the mixing nozzle is also cooled down and consequently an evenly cooled and mixed filler material emerges, as a result of which processing of the filler material is positively influenced.

1. A device (100) for producing a ready-to-use filler material for the filling of surfaces, in particular of vehicle bodywork, by mixing at least two components, in particular a binder component (A) and a hardener component (B), by means of a mixing device (1) comprising a hollow cylindrical stator part (16) and a rotor part (19) that is held in said stator part (16) so as to be concentrically rotatable on a longitudinal axis, and a ring-shaped gap that is created between the rotor part (19) and the stator part (16) and that forms the mixing chamber (14) to form a pasty or liquid mix, wherein the mixing device (1) comprises at least one inlet nozzle (17a) for the supply of the binder component (A) and at least one lead-in nozzle (17b, 17′b, 17″b) for the supply of the hardener component (B), as well as a dispensing opening (21) for dispensing the mix, wherein between the lead-in nozzle (17a, 17b, 17′b, 17″b) and the dispensing opening (21) the mixing chamber (14) is designed, within which mixing chamber (14) the components (A, B) intermix, wherein the device (100) comprises a supporting plate (101) with two perpendicularly standing column-like braces (106, 107) which in the upper region are connected by way of a transverse brace (108), between which braces (106, 107) is arranged a support plate (104′) which forms a filling head (104), with holding devices and receiving devices for a storage device (90) for the binder component (A) and for three storage containers (91, 92, 92′) for the hardener component (B, B1, B2) with piston rods (243, 244, 245, 245′) that are guided in the storage containers (90, 91, 92, 92′), which piston rods (243, 244, 245, 245′) are connected to hydraulic cylinders or some other motorised drive devices (102, 270), wherein an attachment- and guide element for the piston rods is provided above the storage containers (90, 91, 92, 92′), and a first drive device (102) for actuating the hydraulic cylinders or the piston rods for the storage container (90) for the binder component (A) and for two storage containers (91, 92) of the three storage containers (91, 92, 92′) for the hardener component (B, B1, B2) is provided, and a second drive device (250) for the mixing device (1), and a third drive device (270) for actuating the hydraulic cylinder or the piston rod (112), which is preferably a toothed rack, for the third storage container (92′) for the hardener component (B2) are provided, wherein the motorised drive devices (102, 250, 270) are brought together in a program switching device or a control device (280) such that prior to commencement of the mixing process and of actuation of the hydraulic cylinders or of the piston rods for the storage container (90) for the binder component (A) and for the two storage containers (91, 92) for the hardener components (B, B1), the third drive device (270) for the third storage container (92′) for the hardener component (B2) is operated independently of all other functions, so that prior to commencement of the actual mixing process a fore-run of hardener component (B2) takes place for approximately 1 second, wherein after commencement of the rotary movement of the rotor part (19) of the mixing device (1) and the supply of the binder component (A) and of the hardener components (B, B1) the third drive device (270) for the third storage container (92′) for the hardener component (B2) is operated with an after-run of 1 second for the further supply of hardener component B2, wherein in the case of complete discharge of the third storage container (921) for the hardener component (B2) and a toothed rack as a piston rod (245′), driven by the third drive device (270) that is arranged in a box-like container (285) on the transverse brace (108) of the two braces (106, 107) of the base (101), has reached the lower region of the third storage container (92′) for the hardener component (B2), in a further downward movement lifts the box-like container (285), which is attached on one side to the longitudinal brace (106) by means of a hinge, such that the box-like container (285) is lifted by approximately 2 mm, wherein by way of this movement of the box-like container (285) a visual signalling device (290) is operated, and for exchanging the third empty storage container (92′) for the hardener component (B2) for a full storage container the entire device is made inoperative, wherein the supporting plate (101) is designed so as to be movable, and for actuation of the hydraulically operated drive devices for the piston rods for the storage containers (90, 91, 92, 92′) comprises a compressor (400), or for operation of the electric-motor-driven drive devices for the piston rods for the storage containers (90, 91, 92, 92′) and for operation of the mixing device (1) comprises a source (410) of current, and wherein the device is designed as a wall-model or floor-model device that is designed so as to be mobile, driven manually or by motor.

2. The device according to claim 1, wherein the supporting plate (101) of the device (100) comprises a filling head (104), designed as a support plate, for receiving the storage container (90) for the binder component (A) and for receiving the three storage containers (91, 92, 92′) for the hardener component (B, B1, B2), wherein the four storage containers (90, 91, 92, 92′) are positioned on the filling head (104) in a non-slip and fixed manner, wherein their outlets correspond to inlets (207, 208, 209, 209′) of feed channels (204, 205, 206, 206′) in the filling head (104), whose outlets (201, 202, 203, 203′) can be brought into effective connection with the lead-in nozzles (17a, 17b, 17′b, 17″″b) for the binder component (A) and for the hardener component (B, B1, B2) of the mixing device (1) or with the lead-in nozzles (231, 232, 232′) for the hardener component (B, B1, B2) of a catch container (230) that can be exchanged for the mixing device (1), for receiving and disposal of the quantity, determined by overfilling, of hardener components (B, B1, B2) in the storage containers (91, 92, 92′) for the hardener components (B, B1, B2), and wherein the storage containers (90, 91, 92, 92′) in their interior spaces (90, 91a, 92a, 92′a) comprise plate-shaped pistons (240, 241, 242, 242′) that impinge on the container contents, with piston rods (243, 244, 245, 245′) that are movable in longitudinal direction of the containers, by means of motor-drivable hydraulic cylinders or drive devices that are designed in some other way, or by manual operation, by means of which pistons (240, 241, 242, 242′) or piston rods (243, 244, 245, 245′) the contents of the storage containers (91, 92, 92′) for the binder component (A) and for the hardener components (B, B1, B2) can be pressed into the mixing device (1), or partial contents of the storage containers (91, 92, 92′) for the hardener components (B, B1, B2) can be pressed into the catch container (230).

3. The device according to claim 1, wherein the catch container (230) comprises a cup-shaped formed piece (235) that is cylindrical or comprises some other geometric cross-sectional form and that is preferably closed on one side, with the wall (235c) of said formed piece (235) comprising two nozzle stubs (231, 232), arranged side by side and communicating with the interior space (235b) of the formed piece (235), which nozzle stubs (231, 232) are arranged and designed such that by means of the nozzle stubs (231, 232) that can be inserted in the outlets (202, 203) of the filling head (104) for the hardener components (B, B1), the catch container (230) can be clipped onto the filling head (104).

4. The device according to claim 1, wherein on its wall surface (235c) opposite the nozzle stubs (231, 232, 232′) the formed piece (235) of the catch container (230) comprises a nozzle stub (234) which, for holding and centring the catch container (230), is engaged with the handle or the clamping device (103) of the device 100 and with the drive shaft of the drive device (250) suited for the mixing device 1.

5. The device according to claim 1, wherein the piston rods (110, 111, 112) with their plate-shaped pistons (240, 241, 242) for manual operation are connected by way of a handle (260).

6. The device according to claim 1, wherein the mixing device (1) comprises a hollow cylindrical stator part (16) and a rotor part (19), driven by an electric motor, which rotor part (19) is held in said stator part (16) so as to be concentrically rotatable on a longitudinal axis (20), and in that the mixing chamber (14) is formed as a ring-shaped gap between the stator part (16) and the rotor part (19), wherein several first mixing teeth (23) formed on the stator part (16) extend radially inwards, and several second mixing teeth (24) formed on the rotor part (19) extend radially outwards into the mixing chamber (14) so as, by means of rotational movement of the rotor part (19), to move the mixing teeth (23, 24) in the stator part (16) relative to each other, thus achieving mixing of the components (A, B), wherein the stator part (16) comprises three inlets (17b, 17′b, 17″b), connected to the mixing chamber (14), for the hardener components (B, B1, B2).

7. The device according to claim 1, wherein at its end (16a) facing away from the inlets (17a, 17b, 17′b, 17″b), the stator part (16) comprises a ring-shaped holding device (120) with attachment openings (121), which holding device (120) can be undone in the manner of a bayonet connection and is rotatably connected to the stator part (16), wherein rotatability is limited by means of end stops (122, 123; 122a, 123a) such that a fit of the inlet (17a) for the binder component (A) with the infeed for the binder component (A) and at the same time a fit of the inlets (17b, 17′b, 17″b) for the hardener components (B, B1, B2) with the infeed devices for those of the hardener components is achieved, wherein the ring-shaped holding device (120) comprises plastic or metal and two opposing slot-shaped openings (125; 135) that extend in a curved shape parallel to the circumferential edge of the holding device (120), of which slot-shaped openings (125; 135) each comprises two guide sections (125a, 125b; 135a, 135b) of different width, of which the respectively wider guide section (125a; 135a) is designed for inserting an L-shaped guide cam (140; 140′) that is formed on the lower circumferential edge (16a) of the stator part (16), wherein the width of the wider guide section (125a, 135a) corresponds to the length of the free angled limb (140a; 140′a) of the guide cam (140; 140′), and of which guide sections (125, 135) the respective narrower guide section (125b; 135b) comprises a width that corresponds to the thickness of the limb (140b; 140′b) of the L-shaped guide cam (140; 140′), which limb (140b; 140′b) has been formed to the lower circumferential edge (16a) of the stator part (16) and extends parallel to the longitudinal direction of the mixing device (1).

8. The device according to claim 1, wherein the respective outer wall region (125c; 135c) of the narrower guide section (125b; 135b) comprises web-like wall sections (125d; 135d) while forming tongue-like edge regions (127, 137) with groove-like recesses whose depth approximately corresponds to the thickness of the angled limb (140a; 140′a) of the L-shaped guide cam (140, 140′), wherein the number of the L-shaped guide cams may be greater than two L-shaped guide cams.

9. The device according to claim 1, wherein the first mixing teeth (23) are arranged on at least one first mixing tooth plane (10) and the second mixing teeth (24) are arranged on at least one second mixing tooth plane (11), and in that the mixing tooth planes (10, 11) in the direction of the longitudinal axis (20) are axially offset in relation to each other in the manner of levels so that the second mixing teeth (24) of the rotor part (19) radially rotate in the respective gaps of the first mixing teeth (23) of the stator part (16), wherein in each instance the mixing teeth (23, 24) comprise facing areas (30, 31) in order to position them against each other in axial direction in the case of an axially acting force between the stator part (16) and the rotor part (19).

10. The device according to claim 9, wherein in relation to a plane that is arranged normally to the rotational axis, the facing areas (30, 31) are inclined at an angle (a) so that during the mixing process the facing areas (30, 31) slide on each other without material being removed from the mixing teeth (23, 24) and reaching the mix.

11. The device according to claim 1, wherein projections (22) on the end are provided on the rotor part (19), which projections (22) project into the inlet (17a) for the supply of the binder component (A) and rotate along with the rotation of the rotor part (19) in order to reduce the thixotropy of the binder component (A) already in the feed channel of the inlet (17a), wherein the rotor part (19) at its end comprises a hollow cylindrical recess (29) into which a core with a matching geometry can be inserted, by means of which core the rotor part (19) is drivable.

12. The device according to claim 11, wherein the recess (29) comprises catch ribs (25) that extend radially inwards from the body of the rotor part (19), which catch ribs (25) snap into corresponding recesses in the core in order to transmit the drive torque for operating the mixing device (1) from the rotary-driven core to the rotor part (19).

13. The device according to claim 1, wherein the rotor part (19) comprises sealing lips (26) in order to seal the mixing chamber (14) between the rotor part (19) and the stator part (16) and in order to prevent any outflow of mix, wherein the rotor part (19) comprises a cylindrical bearing section (27) in order to create a slide bearing arrangement in the stator part (16) as a radial bearing arrangement, and wherein between the sealing lips (26) a hollow space (28) is created in order to make it possible to catch any mix that flows out through the sealing lips (26).

14. The device according to claim 1, wherein the stator part (16) comprises at least one plate-shaped formed part (18) on the outer circumference, wherein at least one plate-shaped formed part (18) comprises a crescent-shaped catch contour (15) which when the mixing device (1) is inserted is engaged by a pin element in order to secure the radial position of the dispensing opening (21) in the stator part (16).

15. The device according to claim 1, wherein the stator part (16) comprises a support bearing area (12) against which the rotor part (19) rests against the face of the mixing teeth (24) that have been formed to said rotor part (19), and slides off in order to create an axial slide bearing arrangement.

16. The device according to claim 1, wherein the stator part (16) in the cylindrical section of the hollow space (28) circumferentially comprises at least one outlet (13) in order to prevent any outflow of mix from the cylindrical bearing sections (27), and in that at least the stator part (16) is made from a transparent material, wherein the transparent material is selected from the group of plastics comprising polycarbonate (PC), polymethylmetacrylate (PMMA) and/or styrene acrylonitrile (SAN).

17. The device according to claim 1, wherein the formed piece (235) of the catch container (230) comprises a plastic or some other suitable material.

18. The device according to claim 1, wherein the load-bearing structure comprises a transparent protective cover (200), which is to be opened, for covering the storage containers (90, 91, 92, 92′), wherein a protective switch is provided that is in effective connection with the protective cover (200) and the device (100), which protective switch turns the device (100) off when the protective cover is open, which protective cover comprises a transparent plastic or some other suitable material, wherein said protective cover is designed in a door-like manner.

19. The device according to claim 1, wherein the load-bearing structure of the device (100) comprises front and/or rear receptacles (300, 301) for receiving spent or new mixing devices (1).

20. The device according to claim 1, wherein on the load-bearing structure of the device (100), visibly a visual signalling device (350), connected to a source of current, for example a signal light (351) emitting white light or coloured light, and/or an acoustic signalling device (360), such as a signal horn or siren (361), are/is arranged, wherein both signalling devices (350, 360) during start-up of the device (100), for a predetermined period of time, preferably for a period of two or three minutes, are activated by lighting and/or signalling and wherein the signalling device (360) is also activated in the case of a display indicating that the storage container (92′) for the hardener component (B2) is empty.

21. The device according to claim 1, wherein on the supporting plate (101) or in the housing (101′) a container (401) receiving compressed air, and/or a source (410) of current, preferably a rechargeable battery, for 24-volt operation, and/or a drive motor (408) for moving the device are arranged.

22. The device according to claim 1, wherein the device (100) is designed as a floor-model device comprising a base plate or an H-shaped base (130), wherein for mobility the device (100) is arranged and held on a transport table (140) comprising rollers (405), which transport table (140) comprises a top supporting plate (141) to accommodate the device, and a further, shelf-like, supporting plate (142) that receives the container (401) that receives compressed air, of the compressed-air generator and/or a source (410) of current, preferably a rechargeable battery and/or a drive motor (408), to provide mobility for the device (100).

23. The device according to claim 1, wherein in order to extend the pot life of the reaction components, such as hardener components (B) and binder components (A), the storage container (90) comprising the binder components (A) is in effective connection with a refrigeration system in order to cool the binder component (A).

24. The device according to claim 23, wherein for cooling the binder component (A) its storage container is arranged in a closed container (150) that comprises a container insert opening (151) with a closable door, with the interior space (152) of said container (150) being in effective connection with the refrigeration system of a cooling device (155) that is preferably designed as a Peltier refrigeration system, wherein the cooling device (155) is arranged on the base plate or the base (130) of the device (100) or on the mobile transport table (140).

25. The device according to claim 23, wherein for cooling the binder component (A), whose storage container (90) is arranged on a support- and base plate (104′) or cold-transport plate (104″), put in place on the filling head 104 of the device 100, which support- and base plate (104′) or cold-transport plate (104″) comprises at least one channel system (157), which is circular or arranged in some other manner, for the infeed and discharge of a coolant, which storage container (90) is connected to a cooling device (155) that is arranged on the base plate or on the base (130) of the device (100) or on the movable transport table (140), wherein a cold-insulation layer (158) is arranged between the support- and base plate (104′) or the cold-transport plate (104″) for the storage container (90) with the channel (157) that carries the coolant on the one hand, and the non-cooled filling head (104) on the other hand.

26. The device according to claim 23, wherein for cooling the binder component (A), its storage container (90) is arranged on a support- and base plate (104′) or cold-transport plate (104″) which comprises a channel system (157) for the infeed and discharge of a coolant in the form of cooled water from a water container (165) that is arranged in a refrigerator (166), such as a thermoelectrical cool box, and that is connected, preferably by way of a fore-run hose (157′a) and a return hose (157″a), to the channel system (157).
